(19) United States
(12) Patent Application Publication
(10) Pub. No.: US 2025/0087655 A1
(43) Pub. Date: Mar. 13, 2025

(54) METHOD OF MANUFACTURING AN ELECTRODE USING A CONTINUOUS COATING LINE

(71) Applicant: PPG Industries Ohio, Inc., Cleveland, OH (US)

(72) Inventors: Zhilian Zhou, Sewickly, PA (US); Peter Lawrence Votruba-Drzal, Pittsburgh, PA (US); Adam Jacob Crowe, Pittsburgh, PA (US); Stoyan Gary Watsula, Allison Park, PA (US); Ian Lawrence Matts, Pittsburgh, PA (US); Fanghui Wu, Pittsburgh, PA (US); Pengfei Zhan, Pittsburgh, PA (US); Zilu Li, Gibsonia, PA (US); Yurun Yang, Shanghai (CN); Scott William Sisco, Glenshaw, PA (US); Wenqing Liu, Tianjin (CN); Kevin Thomas Sylvester, Pittsburgh, PA (US); Na Zhang

(73) Assignee: PPG Industries Ohio, Inc., Cleveland, OH (US)

(21) Appl. No.: 18/566,130

(22) PCT Filed: Jun. 2, 2022
(86) PCT No.: PCT/CN2022/096792

§ 371 Date: Dec. 1, 2023

Related U.S. Application Data
(60) Provisional application No. 63/250,355, filed on Sep. 30, 2021.
(60) Provisional application No. 63/250,339, filed on Sep. 30, 2021.
(60) Provisional application No. 63/195,866, filed on Jun. 2, 2021.

(51) Int. Cl. H01M 4/04; H01M 4/02; H01M 4/525; H01M 4/62

(52) U.S. Cl. CPC H01M 4/0404; H01M 4/0409; H01M 4/525; H01M 4/623; H01M 4/625; H01M 2004/027; H01M 2004/028

(57) ABSTRACT

The present disclosure provides a method of manufacturing an electrode using a continuous coating line for applying an electrode coating layer on a substrate surface of a substrate, the continuous coating line comprising a coating apparatus comprising a coating head and a coating fluid supply system, and at least one oven comprising a heating element, and a substrate carrier for carrying the substrate, the method comprising continuously carrying the substrate through the continuous coating line using the substrate carrier; continuously applying a battery electrode slurry composition from the coating head to the substrate surface to form a wet coated substrate, wherein the battery electrode slurry composition is continuously fed into the coating head by the coating fluid supply system; and heating the wet coated substrate in the oven to form a dried coating on the substrate.

### FIELD OF THE DISCLOSURE

The disclosure relates to method of manufacturing an electrode using a continuous coating line, and the electrodes produced therefrom for use in electrical storage devices, such as batteries.

### BACKGROUND OF THE DISCLOSURE

Methods and systems are used that can apply a uniform layer or coating to a substrate for the production of lithium ion battery electrodes. The coating process employed may apply a battery electrode slurry for a positive or negative electrode to a current collector to a continuously moving substrate. The continuous coating line layout includes an unwind, coating station, dryer, and rewind. However, this speed at which this process can be run is limited by the solvent evaporation rate, drying time, the lower explosion limit (LEL) of the solvent, and ability to produce high quality electrode. Accordingly, faster line speeds for producing battery electrodes are desired.

### SUMMARY OF THE DISCLOSURE

The present disclosure provides a method of manufacturing an electrode using a continuous coating line for applying an electrode coating layer on a substrate surface of a substrate, the continuous coating line comprising a coating apparatus comprising a coating head and a coating fluid supply system, and at least one oven comprising a heating element, and a substrate carrier for carrying the substrate, the method comprising: continuously carrying the substrate through the continuous coating line using the substrate carrier; continuously applying a battery electrode slurry composition from the coating head to the substrate surface to form a wet coated substrate, wherein the battery electrode slurry composition is continuously fed into the coating head by the coating fluid supply system; and heating the wet coated substrate in the oven to form a dried coating on the substrate; wherein the battery electrode slurry composition comprises: an electrochemically active material comprising a positive battery electrode active material or a negative battery electrode active material; an organic medium comprising, consisting essentially of, or consisting of a trialkyl phosphate; a binder comprising: (a) a fluoropolymer comprising the residue of vinylidene fluoride; and (b) one or more (meth)acrylic polymers comprising constitutional units comprising the residue of: (i) 40% to 80% by weight of an alkyl ester of (meth)acrylic acid containing from 1 to 3 carbon atoms in the alkyl group; (ii) 18% to 48% by weight of an alkyl ester of (meth)acrylic acid containing from 4 to 18 carbon atoms in the alkyl group; (iii) 0.1% to 10% by weight of a hydroxyalkyl ester; (iv) 0% to 10% by weight of an alpha, beta-ethylenically unsaturated carboxylic acid; and (v) 0% to 20% by weight of an ethylenically unsaturated monomer comprising a heterocyclic group, the % by weight based on the total monomer weight that comprise the one or more (meth)acrylic polymers; and optionally an electrically conductive agent.

The present disclosure also provides a method of manufacturing an electrode using a continuous coating line for applying an electrode coating layer on a substrate surface of a substrate, the continuous coating line comprising a coating apparatus comprising a coating head and a coating fluid supply system, and at least one oven comprising a heating element, and a substrate carrier for carrying the substrate, the method comprising: continuously carrying the substrate through the continuous coating line using the substrate carrier; continuously applying a battery electrode slurry composition from the coating head to the substrate surface to form a wet coated substrate, wherein the battery electrode slurry composition is continuously fed into the coating head by the coating fluid supply system; and heating the wet coated substrate in the oven to form a dried coating on the substrate; wherein the battery electrode slurry composition comprises: an electrochemically active material comprising a positive battery electrode active material or a negative battery electrode active material; an organic medium comprising, consisting essentially of, or consisting of: (i) a molecule comprising a sulfoxide functional group; and (ii) a glycol ether and/or ester; wherein the solvent system includes less than 1% by weight of a molecule comprising the structure R¹C(═O)NR²R³, wherein R¹ is an aliphatic saturated group, that can be linear or branched, having 1 to 6 carbon atoms, and substituted by one or more functional groups comprising —C(═O)OR and —C(═O)NR⁴R⁵, R being an alkyl group having 1 to 6 carbon atoms, and R⁴ and R⁵ each independently are methyl or ethyl groups, and R² and R³ each independently are methyl or ethyl groups, based on the weight of the solvent system; a binder comprising a fluoropolymer; and optionally an electrically conductive agent.

The present disclosure also provides a method of manufacturing an electrode using a continuous coating line for applying an electrode coating layer on a substrate surface of a substrate, the continuous coating line comprising a coating apparatus comprising a coating head and a coating fluid supply system, and at least one oven comprising a heating element, and a substrate carrier for carrying the substrate, the method comprising: continuously carrying the substrate through the continuous coating line using the substrate carrier; continuously applying a battery electrode slurry composition from the coating head to the substrate surface to form a wet coated substrate, wherein the battery electrode slurry composition is continuously fed into the coating head by the coating fluid supply system; and heating the wet coated substrate in the oven to form a dried coating on the substrate; wherein the battery electrode slurry composition comprises: an electrochemically active material comprising a positive battery electrode active material or a negative battery electrode active material; an organic medium; a binder comprising a fluoropolymer that is dispersed in the organic medium; and optionally an electrically conductive agent.

The present disclosure also provides an electrode formed from any of the methods of the present disclosure.

The present disclosure further provides an electrical storage device comprising (a) the electrode formed from any of the methods of the present disclosure; (b) a counter-electrode; and (c) an electrolyte.

### DETAILED DESCRIPTION

The present disclosure is directed to a method of manufacturing an electrode using a continuous coating line for applying an electrode coating layer on a substrate surface of a substrate, the continuous coating line comprising a coating apparatus comprising a coating head and a coating fluid supply system, and at least one oven comprising a heating element, and a substrate carrier for carrying the substrate, the method comprising continuously carrying the substrate through the continuous coating line using the substrate carrier; continuously applying a battery electrode slurry composition from the coating head to the substrate surface to form a wet coated substrate, wherein the battery electrode slurry composition is continuously fed into the coating head by the coating fluid supply system; and heating the wet coated substrate in the oven to form a dried coating on the substrate; wherein the battery electrode slurry composition comprises an electrochemically active material comprising a positive battery electrode active material or a negative battery electrode active material; an organic medium; a binder comprising a fluoropolymer that is dispersed or solubilized in the organic medium; and optionally an electrically conductive agent.

According to the present disclosure, the method further comprises continuously carrying the substrate through the continuous coating line using the substrate carrier. Accordingly, the continuous coating line further comprises a substrate carrier for carrying the substrate. The substrate carrier is not limited and may comprise any suitable substrate carrier. For example, the continuous coating line may comprise a roll-to-roll coating line wherein the substrate is unwound from a roll (turret) and is carried through the continuous coating line on a series of rolls and is rewound onto a roll (turret) at the end of the coating line.

The substrate carrier for carrying the substrate may move the substrate through the continuous coating line at a line speed of at least 1 meters/minute (mpm), such as at least 2 mpm, such as at least 4 mpm, such as at least 8 mpm, such as at least 12 mpm, such as at least 16 mpm, such as at least 18 mpm, such as at least 20 mpm, such as at least 22 mpm, such as at least 24 mpm, such as at least 30 mpm, such as at least 35 mpm, such as at least 40 mpm, such as at least 45 mpm, such as at least 50 mpm, such as at least 55 mpm, such as at least 60 mpm, such as at least 61 mpm, such as at least 70 mpm, such as at least 81 mpm, such as at least 101 mpm.

According to the present disclosure, the method comprises continuously applying a battery electrode slurry composition from the coating head to the substrate surface to form a wet coated substrate, wherein the battery electrode slurry composition is continuously fed into the coating head by the coating fluid supply system. Accordingly, the continuous coating line comprises a coating apparatus comprising a coating head. The coating head may comprise any suitable coating head. For example, the coating head may comprise a slot-die coater or a reverse comma coater, among others.

The coating apparatus also comprises a coating fluid supply system. The coating fluid supply system regulates the flow of the battery electrode slurry composition to the coating head to enable uniform coating application. The coating fluid supply system may comprise any suitable system. The coating fluid supply system may comprise, for example, a supply pump, a flow control valve, and a supply line.

According to the present disclosure, the method further comprises heating the wet coated substrate in the oven to form a dried coating on the substrate. Accordingly, the continuous coating line further comprises at least one oven comprising a heating element. The oven is not limited and may comprise any suitable oven. The oven is structured and arranged such that the substrate passes through and is subjected to elevated temperature from the heating element. The heating element is not limited and may comprise any suitable heating element. For example, the heating element may be electric, steam heated, or oil heated. The temperature of the oven may be at least 50° C., such as at least 60° C., such as at least 70° C., such as at least 80° C., such as at least 90° C., such as at least 95° C., such as at least 100° C., such as at least 110° C., such as at least 120° C., such as at least 130° C., such as at least 140° C. The temperature of the oven may be no more than 150° C., such as no more than 140° C., such as no more than 130° C., such as no more than 120° C., such as no more than 110° C., such as no more than 100° C., such as no more than 90° C., such as no more than 80° C., such as no more than 70° C., such as no more than 60° C. The temperature of the oven may be 50° C. to 150° C., such as 50° C. to 140° C., such as 50° C. to 130° C., such as 50° C. to 120° C., such as 50° C. to 110° C., such as 50° C. to 100° C., such as 50° C. to 90° C., such as 50° C. to 80° C., such as 50° C. to 70° C., such as 50° C. to 60° C., such as 60° C. to 150° C., such as 60° C. to 140° C., such as 60° C. to 130° C., such as 60° C. to 120° C., such as 60° C. to 110° C., such as 60° C. to 100° C., such as such as 60° C. to 90° C., such as 60° C. to 80° C., such as 60° C. to 70° C., such as 70° C. to 150° C., such as 70° C. to 140° C., such as 70° C. to 130° C., such as 70° C. to 120° C., such as 70° C. to 110° C., such as 70° C. to 100° C., such as 70° C. to 90° C., such as 70° C. to 80° C., such as 80° C. to 150° C., such as 80° C. to 140° C., such as 80° C. to 130° C., such as 80° C. to 120° C., such as 80° C. to 110° C., such as 80° C. to 100° C., such as 80° C. to 90° C., such as 90° C. to 150° C., such as 90° C. to 140° C., such as 90° C. to 130° C., such as 90° C. to 120° C., such as 90° C. to 110° C., such as 90° C. to 100° C., such as 95° C. to 150° C., such as 95° C. to 140° C., such as 95° C. to 130° C., such as 95° C. to 120° C., such as 95° C. to 110° C., such as 95° C. to 100° C., such as 100° C. to 150° C., such as 100° C. to 140° C., such as 100° C. to 130° C., such as 100° C. to 120° C., such as 100° C. to 110° C., such as 110° C. to 150° C., such as 110° C. to 140° C., such as 110° C. to 130° C., such as 110° C. to 120° C., such as 120° C. to 150° C., such as 120° C. to 140° C., such as 120° C. to 130° C., such as 130° C. to 150° C., such as 130° C. to 140° C., such as 140° C. to 150° C.

As mentioned above, the continuous coating line may comprise more than one oven, such as at least 2 ovens, such as at least 3 ovens, such as at least 4 ovens, such as at least 5 ovens, such as at least 6 ovens, such as at least 7 ovens, such as at least 8 ovens, or more.

The at least one oven or combination or ovens may form varying heating zones throughout the length of the oven(s). Each zone may be heated to the same temperature or each may independently be a different temperature. For example, each heating zone may have the same temperature, the heating zones may increase in temperature as the substrate moves further down the heating zones of the continuous coating line, the heating zones may decrease in temperature as the substrate moves further down the heating zones of the continuous coating line, or the heating zones may be more varied in temperature (e.g., first heating zone higher temperature than second heating zone and third through the end increase in temperature relative to the second heating zone).

The oven length is not limited and may be any suitable length. For example, the oven may have a length of at least 1 meter, such as at least 5 meters, such as at least 10 meters, such as at least 15 meters, such as at least 18 meters, such as at least 18.29 meters, such as at least 35 meters, such as 35 meters. The oven may have a length of no more than 80 meters, such as no more than 60 meters, such as no more than 40 meters, such as no more than 35 meters, such as no more than 30 meters, such as no more than 20 meters. The oven may have a length of 1 to 80 meters, such as 1 to 60 meters, such as 1 to 40 meters, such as 1 to 35 meters, such as 1 to 30 meters, such as 1 to 20 meters, such as 5 to 80 meters, such as 5 to 60 meters, such as 5 to 40 meters, such as 5 to 35 meters, such as 5 to 30 meters, such as 5 to 20 meters, such as 10 to 80 meters, such as 10 to 60 meters, such as 10 to 40 meters, such as 10 to 35 meters, such as 10 to 30 meters, such as 10 to 20 meters, such as 15 to 80 meters, such as 15 to 60 meters, such as 15 to 40 meters, such as 15 to 35 meters, such as 15 to 30 meters, such as 15 to 20 meters, such as 18 to 80 meters, such as 18 to 60 meters, such as 18 to 40 meters, such as 18 to 35 meters, such as 18 to 30 meters, such as 18 to 20 meters, such as 18.29 to 80 meters, such as 18.29 to 60 meters, such as 18.29 to 40 meters, such as 18.29 to 35 meters, such as 18.29 to 30 meters, such as 18.29 to 20 meters, such as 35 to 80 meters, such as 35 to 60 meters, such as 35 to 40 meters.

The residence time of the substrate in the oven is not limited and may be, for example, 5 minutes or less, such as 3 minutes or less, such as 2 minutes or less, such as 1 minute or less, such as 50 seconds or less, such as 45 seconds or less, such as 40 seconds or less.

A ratio of the line speed of the substrate carried by the substrate carrier to the oven length is not limited and may be, for example, at least 1 mpm to 5 meter of oven length (1:5), such as at least 1:3, such as at least 1:2, such as at least 1:1, such as at least 1.1:1, such as at least 1.2:1, such as at least 1.3:1, such as at least 1.4:1, such as at least 1.5:1.

The oven further comprises an air supply that flows through the oven. The air flow rate will depend upon the amount and type of solvent being evaporated by the line because the concentration of solvent in the air of the oven must be below the lower explosion limit for the organic medium. The air may be recirculated such that a portion of the air is recirculated back into the oven after it is optionally put forth a solvent recovery process. The amount of air is also limited by the air blower.

The coating may be applied to both sides of the substrate at the same time as it moves through the continuous coating line. Alternatively, the coating may be applied in sequential steps to both sides of the substrate prior to drying the applied coating. Another alternative is that a first coating may be applied to one side of the substrate, and then a second coating may be applied to the other side of the substrate following drying of the first applied coating. The substrate may be re-fitted onto the coating line to apply the second coating or flipped with the direction of the movement of the substrate being reversed on the continuous coating line to apply the second coating. In the latter case, the continuous coating line would comprise a second coating apparatus positioned on the other side of the oven(s).

The continuous coating line may optionally comprise a solvent recovery system. The solvent recovery system is not limited and may comprise any suitable system. For example, the solvent recovery system may comprise, for example, a condenser, a water-scrubber, zeolite wheel, carbon bed, or any combination thereof, among others. The solvent recovery system may also optionally comprise a distillation column for purification of the recovered solvent.

The continuous coating line may optionally further comprise a substrate cleaner to remove any particulates (e.g., dust) on the surface of the substrate as it is unwound from the roll and prior to further processing on the continuous coating line. The cleaner does not chemically modify the substrate surface. The cleaner is not limited and any suitable cleaner may be used.

The continuous coating line may optionally further comprise a substrate treatment apparatus structured and arranged to treat the surface of the substrate prior to coating. For example, the treatment may comprise a corona discharge, other methods of modifying the surface energy of the surface of the substrate, and/or a pretreatment composition.

As used herein, the term “pretreatment composition” refers to a composition that upon contact with the surface of the substrate, reacts with and chemically alters the substrate surface and binds to it to form a protective layer. The optional pretreatment composition may be a pretreatment composition comprising a group IIIB and/or IVB metal. As used herein, the term “group IIIB and/or IVB metal” refers to an element that is in group IIIB or group IVB of the CAS Periodic Table of the Elements as is shown, for example, in the Handbook of Chemistry and Physics, 63^{rd} edition (1983). Where applicable, the metal themselves may be used, however, a group IIIB and/or IVB metal compound may also be used. As used herein, the term “group IIIB and/or IVB metal compound” refers to compounds that include at least one element that is in group IIIB or group IVB of the CAS Periodic Table of the Elements. Suitable pretreatment compositions are described in U.S. Pat. No. 9,273,399 at col. 4, line 60 to col. 10, line 26, the cited portion of which is incorporated herein by reference.

The continuous coating line may optionally comprise one or more sources of actinic or electromagnetic radiation positioned along the coating line after the substrate is coated by the coating apparatus. The sources of actinic or electromagnetic radiation may be positioned prior to the substrate entering the oven, after the substrate leaves the oven, or at both locations. The sources of actinic or electromagnetic radiation are not limited and any suitable source may be used. For example, a non-limiting example of a source of actinic radiation is a UV lamp.

As mentioned above, a battery electrode slurry composition is continuously applied to the surface of the substrate. The battery electrode slurry composition comprises an electrochemically active material comprising a positive battery electrode active material or a negative battery electrode active material; an organic medium; a binder comprising a fluoropolymer; and optionally an electrically conductive agent.

The battery electrode slurry may have a viscosity of at least 500 cP at 10 s⁻¹, such as at least 2,000 cP at 10 s⁻¹, such as at least 3,000 cP at 10 s⁻¹, such as at least 5,000 cP at 10 s⁻¹, such as at least 10,000 cP at 10 s⁻¹, as measured by Anton Paar MCR 302 rheometer with a 50 mm diameter cone-plate. The battery electrode slurry may have a viscosity of no more than 20,000 cP at 10 s⁻¹, such as no more than 15,000 cP at 10 s⁻¹, such as no more than 10,000 cP at 10 s⁻¹, such as no more than 8,000 cP at 10 s⁻¹, as measured by Anton Paar MCR 302 rheometer with a 50 mm diameter cone-plate. The battery electrode slurry may have a viscosity of 500 to 20,000 cP at 10 s⁻¹, such as 500 to 15,000 cP at 10 s⁻¹, such as 500 to 10,000 cP at 10 s⁻¹, such as 500 to 8,000 cP at 10 s⁻¹, such as 2,000 to 20,000 cP at 10 s⁻¹, such as 2,000 to 15,000 cP at 10 s⁻¹, such as 2,000 to 10,000 cP at 10 s⁻¹, such as 2,000 to 8,000 cP at 10 s⁻¹, such as 3,000 to 20,000 cP at 10 s⁻¹, such as 3,000 to 15,000 cP at 10 s⁻¹, such as 3,000 to 10,000 cP at 10 s⁻¹, such as 3,000 to 8,000 cP at 10 s⁻¹, such as 5,000 to 20,000 cP at 10 s⁻¹, such as 5,000 to 15,000 cP at 10 s⁻¹, such as 5,000 to 10,000 cP at 10 s⁻¹, such as 5,000 to 8,000 cP at 10 s⁻¹, such as 10,000 to 20,000 cP at 10 s⁻¹, such as 10,000 to 15,000 cP at 10 s⁻¹, as measured by Anton Paar MCR 302 rheometer with a 50 mm diameter cone-plate.

The organic medium may have an evaporation rate of at least at least 45 kg/hr, such as at least 100 kg/hr, such as at least 110 kg/hr, such as at least 120 kg/hr, such as at least 130 kg/hr, such as at least 140 kg/hr, such as at least 150 kg/hr. The evaporation rate is not limited and may be lower or higher and will vary upon a number of variables such as the size and operating conditions of the oven.

The organic medium may have a lower explosion limit of greater than 1.1% by volume, such as at least 1.2% by volume, such as at least 1.3% by volume, such as at least 1.4% by volume, such as at least 1.5% by volume, such as at least 1.6% by volume.

The battery electrode slurry may have a solids content of at least 30% by weight, such as at least 35% by weight, such as at least 40% by weight, such as at least 45% by weight, such as at least 50% by weight, such as at least 52% by weight, such as at least 55% by weight, such as at least 58% by weight, such as at least 60% by weight, such as at least 62% by weight, such as at least 65% by weight, such as at least 68% by weight, such as at least 70% by weight, such as at least 72% by weight, such as at least 75% by weight, such as at least 76% by weight, such as at least 80% by weight, such as at least 82% by weight, such as at least 85% by weight, such as at least 90% by weight, based on the total weight of the battery electrode slurry. The battery electrode slurry may have a solids content of no more than 90% by weight, such as no more than 85% by weight, such as no more than 80% by weight, such as no more than 75% by weight, such as no more than 70% by weight, such as no more than 65% by weight, such as no more than 60% by weight, such as no more than 55% by weight, such as no more than 50% by weight, such as no more than 45% by weight, such as no more than 40% by weight, such as no more than 35% by weight, based on the total weight of the battery electrode slurry. The battery electrode slurry may have a solids content of 30% to 90% by weight, such as 30% to 85% by weight, such as 30% to 80% by weight, such as 30% to 75% by weight, such as 30% to 70% by weight, such as 30% to 65% by weight, such as 30% to 60% by weight, such as 30% to 55% by weight, such as 30% to 50% by weight, such as 30% to 45% by weight, such as 30% to 40% by weight, such as 30% to 35% by weight, such as 35% to 90% by weight, such as 35% to 85% by weight, such as 35% to 80% by weight, such as 35% to 75% by weight, such as 35% to 70% by weight, such as 35% to 65% by weight, such as 35% to 60% by weight, such as 35% to 55% by weight, such as 35% to 50% by weight, such as 35% to 45% by weight, such as 35% to 40% by weight, such as 40% to 90% by weight, such as 40% to 85% by weight, such as 40% to 80% by weight, such as 40% to 75% by weight, such as 40% to 70% by weight, such as 40% to 65% by weight, such as 40% to 60% by weight, such as 40% to 55% by weight, such as 40% to 50% by weight, such as 40% to 45% by weight, such as 45% to 90% by weight, such as 45% to 85% by weight, such as 45% to 80% by weight, such as 45% to 75% by weight, such as 45% to 70% by weight, such as 45% to 65% by weight, such as 45% to 60% by weight, such as 45% to 55% by weight, such as 45% to 50% by weight, such as 50% to 90% by weight, such as 50% to 85% by weight, such as 50% to 80% by weight, such as 50% to 75% by weight, such as 50% to 70% by weight, such as 50% to 65% by weight, such as 50% to 60% by weight, such as 50% to 55% by weight, such as 55% to 90% by weight, such as 55% to 85% by weight, such as 55% to 80% by weight, such as 55% to 75% by weight, such as 55% to 70% by weight, such as 55% to 65% by weight, such as 55% to 60% by weight, such as 60% to 90% by weight, such as 60% to 85% by weight, such as 60% to 80% by weight, such as 60% to 75% by weight, such as 60% to 70% by weight, such as 60% to 65% by weight, such as 65% to 90% by weight, such as 65% to 85% by weight, such as 65% to 80% by weight, such as 65% to 75% by weight, such as 65% to 70% by weight, such as 70% to 90% by weight, such as 70% to 85% by weight, such as 70% to 80% by weight, such as 70% to 75% by weight, such as 75% to 90% by weight, such as 75% to 85% by weight, such as 75% to 80% by weight, such as 80% to 90% by weight, such as 80% to 85% by weight, such as 85% to 90% by weight, based on the total weight of the battery electrode slurry.

The solids content may depend upon the electrochemically active material used. For example, if the electrochemically active material is lithium iron phosphate, the solids content may be any described above, including, but not limited to, 35% to 65% by weight, such as 35% to 60% by weight, such as 35% to 55% by weight, such as 35% to 50% by weight, such as 35% to 45% by weight, such as 35% to 40% by weight, such as 40% to 65% by weight, such as 40% to 60% by weight, such as 40% to 55% by weight, such as 40% to 50% by weight, such as 40% to 45% by weight, such as 45% to 65% by weight, such as 45% to 60% by weight, such as 45% to 55% by weight, such as 45% to 50% by weight, such as 50% to 65% by weight, such as 50% to 60% by weight, such as 50% to 55% by weight, based on the total weight of the battery electrode slurry. In other examples, if the electrochemically active material is NMC (LiNi_{0.8} Mn_{0.1}Co_{0.1}O₂), the solids content may be any described above, including, but not limited to, 55% to 90% by weight, such as 55% to 85% by weight, such as 55% to 80% by weight, such as 55% to 75% by weight, such as 55% to 70% by weight, such as 55% to 65% by weight, such as 55% to 60% by weight, such as 60% to 90% by weight, such as 60% to 85% by weight, such as 60% to 80% by weight, such as 60% to 75% by weight, such as 60% to 70% by weight, such as 60% to 65% by weight, such as 65% to 90% by weight, such as 65% to 85% by weight, such as 65% to 80% by weight, such as 65% to 75% by weight, such as 65% to 70% by weight, such as 70% to 90% by weight, such as 70% to 85% by weight, such as 70% to 80% by weight, such as 70% to 75% by weight, such as 75% to 90% by weight, such as 75% to 85% by weight, such as 75% to 80% by weight, such as 80% to 90% by weight, such as 80% to 85% by weight, such as 85% to 90% by weight, based on the total weight of the battery electrode slurry.

As used herein, “solids content” refers to the non-solvent portion of the battery electrode slurry composition including at least the fluoropolymer, other optional components of the binder (e.g., crosslinking agent, dispersant, etc., if present), the electrochemically active material, and the electrically conductive agent, if present.

According to the present disclosure, the battery electrode slurry composition comprises an organic medium. As used herein, the term “organic medium” refers to a liquid medium comprising less than 50% by weight water, based on the total weight of the organic medium. Such organic mediums may comprise less than 40% by weight water, or less than 30% by weight water, or less than 20% by weight water, or less than 10% by weight water, or less than 5% by weight water, or less than 1% by weight water, or less than 0.1% by weight water, based on the total weight of the organic medium, or may be free of water. Organic solvent(s) comprise more than 50% by weight of the organic medium, such as at least 70% by weight, such as at least 80% by weight, such as at least 90% by weight, such as at least 95% by weight, such as at least 99% by weight, such as at least 99.9% by weight, such as 100% by weight, based on the total weight of the organic medium. The organic solvent(s) may comprise 50.1% to 100% by weight, such as 70% to 100% by weight, such as 80% to 100% by weight, such as 90% to 100% by weight, such as 95% to 100% by weight, such as 99% to 100% by weight, such as 99.9% to 100% by weight, based on the total weight of the organic medium.

The organic medium optionally may be capable of dispersing the fluoropolymer at room temperature and standard atmospheric pressure. However, the fluoropolymer may solubilize in the organic medium at elevated temperatures and standard atmospheric pressure. For example, the dissolution temperature of the fluoropolymer dispersed in the organic medium may range from 30° C. to 77° C., such as from 30° C. to 70° C., such as 30° C. to 65° C., such as 30° C. to 60° C., such as 30° C. to 55° C., such as 30° C. to 50° C., such as 40° C. to 77° C., such as from 40° C. to 70° C., such as 40° C. to 65° C., such as 40° C. to 60° C., such as 40° C. to 55° C., such as 40° C. to 50° C., such as 50° C. to 77° C., such as from 50° C. to 70° C., such as 50° C. to 65° C., such as 50° C. to 60° C., such as 50° C. to 55° C. The dissolution temperature may be measured according to the method discussed herein.

When the fluoropolymer is dispersed in the organic medium, the organic solvent is not limited so long as it can disperse fluoropolymer at room temperature and standard atmospheric pressure. The organic medium may comprise a single solvent or a combination of solvents. If a combination of solvents is used, one of the solvents may solubilize fluoropolymer at room temperature and standard atmospheric pressure, but in combination the solvent does not solubilize fluoropolymer at room temperature and standard atmospheric pressure.

The organic medium may comprise, for example, butyl pyrrolidone, trialkyl phosphate, 1,2,3-triacetoxypropane, 3-methoxy-N,N-dimethylpropanamide, ethyl acetoacetate, gamma-butyrolactone, propylene glycol methyl ether, cyclohexanone, propylene carbonate, dimethyl adipate, propylene glycol methyl ether acetate, dibasic ester (DBE), dibasic ester 5 (DBE-5), 4-hydroxy-4-methyl-2-pentanone (diacetone alcohol), propylene glycol diacetate, dimethyl phthalate, methyl isoamyl ketone, ethyl propionate, 1-ethoxy-2-propanol, dipropylene glycol dimethyl ether, saturated and unsaturated linear and cyclic ketones (commercially available as a mixture thereof as Eastman™ C-11 Ketone from Eastman Chemical Company), diisobutyl ketone, acetate esters (commercially available as Exxate™ 1000 from Hallstar), tripropylene glycol methyl ether, diethylene glycol ethyl ether acetate, or combinations thereof that allow for the fluoropolymer to be in a dispersed state in the organic medium at room temperature and standard atmospheric pressure. The trialkyl phosphate may comprise, for example, trimethyl phosphate, triethyl phosphate, tripropyl phosphate, tributyl phosphate, or the like.

The organic medium may comprise a primary solvent and a co-solvent that form a homogenous continuous phase with the fluoropolymer as the dispersed phase. The primary solvent and co-solvent and relevant amounts thereof may be selected to provide a dispersion of the fluoropolymer in the organic medium at room temperature, i.e., about 23° C. Both the primary solvent and co-solvent may comprise organic solvent(s). The fluoropolymer may be soluble in the primary solvent at room temperature if used alone but use of the co-solvent with the primary solvent may allow for the fluoropolymer to be stably dispersed in the organic medium. The primary solvent may comprise, consist essentially of, or consist of, for example, butyl pyrrolidone, N-methyl-2-pyrrolidone, a trialkylphosphate, 3-methoxy-N,N-dimethylpropanamide, 1,2,3-triacetoxypropane, or combinations thereof. The co-solvent may comprise, consist essentially of, or consist of, for example, ethyl acetoacetate, gamma-butyrolactone, and/or glycol ethers such as propylene glycol methyl ether, dipropylene glycol methyl ether, propylene glycol monopropyl ether, diethylene glycol monobutyl ether, ethylene glycol monohexyl ether, and the like. The primary solvent may be present in an amount of at least 50% by weight, such as at least 65% by weight, such as at least 75 by weight, and may be present in an amount of no more than 99% by weight, such as no more than 90% by weight, such as no more than 85% by weight, based on the total weight of the organic medium. The primary solvent may be present in an amount of 50% to 99% by weight, such as 65% to 90% by weight, such as 75% to 85% by weight, based on the total weight of the organic medium. The co-solvent may be present in an amount of at least 1% by weight, such as at least 10% by weight, such as at least 15% by weight, and may be present in an amount of no more than 50% by weight, such as no more than 35% by weight, such as no more than 25% by weight. The co-solvent may be present in an amount of 1% to 50% by weight, such as 10% to 35% by weight, such as 15% to 25% by weight, based on the total weight of the organic medium.

The organic medium optionally may have an evaporation rate less than 10 g/min m², at the dissolution temperature of the fluoropolymer dispersed in the organic medium. Evaporation rates may be measured using ASTM D3539 (1996). The dissolution temperature of the fluoropolymer dispersed in the organic medium may be determined by measuring complex viscosity of the mixture as a function of temperature. This technique may be applied to fluoropolymers (in addition to other types of polymer) mixed in an organic medium where the total mass of non-volatile solids content of such mixtures is from 44% to 46%, such as 45% of the total mass of the mixture. Complex viscosity may be measured with an Anton-Paar MCR301 rheometer using a 50 millimeter cone and temperature-controlled plate. The complex viscosity of fluoropolymer mixtures is measured over a temperature range from 20° C. to at least 75° C. with a temperature ramp rate of 10° C. per minute, an oscillatory frequency of 1 Hz, and a stress amplitude setpoint of 90 Pa. The dissolution of fluoropolymer in the organic medium is indicated by a sharp increase in the complex viscosity as temperature increased. The dissolution temperature is defined as the temperature at which the rate of change in viscosity with increasing temperature is highest and is calculated by determining the temperature at which the first derivative with respect to temperature of the Log₁₀ of the complex viscosity reaches a maximum. The table below illustrates dissolution temperatures determined according to this method using PVDF T-1 from Inner Mongolia 3F Wanhao Fluorochemical Co. Ltd. (PVDF T-1 has a particle size of about 330 to 380 nm and a weight average molecular weight of about 130,000 to 160,000 g/mol), in various solvents or solvent mixtures as listed.

| | Solvent | | Cosolvent | | | |
|---|---|---|---|---|---|---|
| | % mass of | | % mass of | PVDF % | | Evaporation rate |
| | organic | | organic | mass of | Dissolution | at Dissolution |
| Solvent | medium | Cosolvent | medium | mixture | Temp (° C.) | Temp (g/min m²) |
| N-butylpyrrolidone | 100 | — | — | 45 | 48 | — |
| gamma- | 100 | — | — | 45 | 51 | 9.31 |
| butyrolactone | | | | | | |
| Isophorone | 100 | — | — | 45 | 72 | 16.59 |
| Triacetin | 100 | — | — | 45 | 76 | 0.69 |
| Ethyl Acetoacetate | 100 | — | — | 45 | 76 | 37.76 |
| Triethylphosphate | 80 | Ethyl | 20 | 45 | 46 | — |
| | | Acetoacetate | | | | |
| Triethylphosphate | 80 | Dowanol ™ | 20 | 45 | 58 | — |
| | | PM¹ | | | | |

¹Propylene glycol methyl ether commercially available from The Dow Chemical Company.

The organic medium may optionally have an evaporation rate greater than 80 g/min m², at 180° C., such as greater than 90 g/min m², at 180° C., such as greater than 100 g/min m², at 180° C.

Alternatively, the organic medium may dissolve the fluoropolymer at room temperature and standard atmospheric pressure. For example, the organic medium may (A) comprise, consist essentially of, or consist of a trialkyl phosphate; (B) comprise a solvent system comprising, consisting essentially of, or consisting of (i) a molecule comprising a sulfoxide functional group and (ii) a glycol ether and/or ester, wherein the solvent system includes less than 1% by weight of a molecule comprising the structure R¹C(═O)NR²R³, wherein R¹ is an aliphatic saturated group, that can be linear or branched, having 1 to 6 carbon atoms, and substituted by one or more functional groups comprising —C(═O)OR and —C(═O)NR⁴R⁵, R being an alkyl group having 1 to 6 carbon atoms, and R⁴ and R⁵ each independently are methyl or ethyl groups, and R² and R³ each independently are methyl or ethyl groups, based on the weight of the solvent system; or (C) a solvent system comprising (i) a trialkyl phosphate and (ii) a co-solvent comprising a lactone and/or a molecule comprising a sulfoxide and/or sulfone functional group, wherein the trialkyl phosphate and the co-solvent comprise at least 50% by weight of the solvent system, based on the total weight of the solvent system.

As mentioned above, the organic medium may comprise a solvent system comprising (i) a molecule comprising a sulfoxide functional group; and (ii) a glycol ether and/or ester, wherein the solvent system comprises less than 1% by weight of a molecule comprising the structure R¹C(═O)NR²R³, wherein R¹ is an aliphatic saturated group, that can be linear or branched, having 1 to 6 carbon atoms, and substituted by one or more functional groups comprising —C(═O)OR and —C(═O)NR⁴R⁵, R being an alkyl group having 1 to 6 carbon atoms, and R⁴ and R⁵ each independently are methyl or ethyl groups, and R² and R³ each independently are methyl or ethyl groups, based on the weight of the solvent system.

As used herein, the term “solvent system” refers to the combination of solvents used in the composition. The solvent system of the present disclosure may comprise, consist essentially of, or consist of (i) a molecule comprising a sulfoxide functional group, and (ii) a glycol ether and/or ester.

The molecule comprising a sulfoxide functional group may comprise any suitable molecule comprising a sulfoxide functional group. For example, the molecule comprising a sulfoxide functional group may comprise, consist essentially of, or consist of dimethyl sulfoxide.

The glycol ether may comprise any suitable glycol ether. For example, the glycol ether may comprise, consist essentially of, or consist of di(propylene glycol) methyl ether acetate.

The ester may comprise any suitable ester. For example, the ester may comprise, consist essentially of, or consist of a dibasic ester, such as, for example, dimethyl esters of adipic acid, glutaric acid, and/or succinic acid. A non-limiting commercial example includes DBE-5.

The molecule comprising a sulfoxide functional group may be present in the solvent system in an amount of at least 0.1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, such as at least 95% by weight, such as at least 99% by weight, based on the total weight of the solvent system. The molecule comprising a sulfoxide functional group may be present in the solvent system in an amount of no more than 99.9% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the solvent system. The molecule comprising a sulfoxide functional group may be present in the solvent system in an amount of 0.1% to 99.9% by weight, such as 5% to 99.9% by weight, such as 10% to 99.9% by weight, such as 20% to 99.9% by weight, such as 30% to 99.9% by weight, such as 40% to 99.9% by weight, such as 50% to 99.9% by weight, such as 60% to 99.9% by weight, such as 70% to 99.9% by weight, such as 80% to 99.9% by weight, such as 90% to 99.9% by weight, such as 95% to 99.9% by weight, such as 5% to 95% by weight, such as 5% to 95% by weight, such as 10% to 95% by weight, such as 20% to 95% by weight, such as 30% to 95% by weight, such as 40% to 95% by weight, such as 50% to 95% by weight, such as 60% to 95% by weight, such as 70% to 95% by weight, such as 80% to 95% by weight, such as 90% to 95% by weight, such as 0.1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as such as 0.1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.1% to 50% by weight, such as 5% to 50% by weight, such as 10% to 50% by weight, such as 20% to 50% by weight, such as 30% to 50% by weight, such as 40% to 50% by weight, such as 0.1% to 40% by weight, such as 5% to 40% by weight, such as 10% to 40% by weight, such as 20% to 40% by weight, such as 30% to 40% by weight, such as 0.1% to 30% by weight, such as 5% to 30% by weight, such as 10% to 30% by weight, such as 20% to 30% by weight, such as 0.1% to 20% by weight, such as 5% to 20% by weight, such as 10% to 20% by weight, such as 0.1% to 10% by weight, such as 5% to 10% by weight, based on the total weight of the solvent system.

The glycol ether and/or ester may be present in the solvent system in an amount of at least 0.1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, such as at least 95% by weight, such as at least 99% by weight, based on the total weight of the solvent system. The glycol ether and/or ester may be present in the solvent system in an amount of no more than 99.9% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the solvent system. The glycol ether and/or ester may be present in the solvent system in an amount of 0.1% to 99.9% by weight, such as 5% to 99.9% by weight, such as 10% to 99.9% by weight, such as 20% to 99.9% by weight, such as 30% to 99.9% by weight, such as 40% to 99.9% by weight, such as 50% to 99.9% by weight, such as 60% to 99.9% by weight, such as 70% to 99.9% by weight, such as 80% to 99.9% by weight, such as 90% to 99.9% by weight, such as 95% to 99.9% by weight, such as 5% to 95% by weight, such as 5% to 95% by weight, such as 10% to 95% by weight, such as 20% to 95% by weight, such as 30% to 95% by weight, such as 40% to 95% by weight, such as 50% to 95% by weight, such as 60% to 95% by weight, such as 70% to 95% by weight, such as 80% to 95% by weight, such as 90% to 95% by weight, such as 0.1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as such as 0.1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.1% to 50% by weight, such as 5% to 50% by weight, such as 10% to 50% by weight, such as 20% to 50% by weight, such as 30% to 50% by weight, such as 40% to 50% by weight, such as 0.1% to 40% by weight, such as 5% to 40% by weight, such as 10% to 40% by weight, such as 20% to 40% by weight, such as 30% to 40% by weight, such as 0.1% to 30% by weight, such as 5% to 30% by weight, such as 10% to 30% by weight, such as 20% to 30% by weight, such as 0.1% to 20% by weight, such as 5% to 20% by weight, such as 10% to 20% by weight, such as 0.1% to 10% by weight, such as 5% to 10% by weight, based on the total weight of the solvent system.

The glycol ether may be present in the solvent system in an amount of at least 0.1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, such as at least 95% by weight, such as at least 99% by weight, based on the total weight of the solvent system. The glycol ether may be present in the solvent system in an amount of no more than 99.9% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the solvent system. The glycol ether may be present in the solvent system in an amount of 0.1% to 99.9% by weight, such as 5% to 99.9% by weight, such as 10% to 99.9% by weight, such as 20% to 99.9% by weight, such as 30% to 99.9% by weight, such as 40% to 99.9% by weight, such as 50% to 99.9% by weight, such as 60% to 99.9% by weight, such as 70% to 99.9% by weight, such as 80% to 99.9% by weight, such as 90% to 99.9% by weight, such as 95% to 99.9% by weight, such as 5% to 95% by weight, such as 5% to 95% by weight, such as 10% to 95% by weight, such as 20% to 95% by weight, such as 30% to 95% by weight, such as 40% to 95% by weight, such as 50% to 95% by weight, such as 60% to 95% by weight, such as 70% to 95% by weight, such as 80% to 95% by weight, such as 90% to 95% by weight, such as 0.1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as such as 0.1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.1% to 50% by weight, such as 5% to 50% by weight, such as 10% to 50% by weight, such as 20% to 50% by weight, such as 30% to 50% by weight, such as 40% to 50% by weight, such as 0.1% to 40% by weight, such as 5% to 40% by weight, such as 10% to 40% by weight, such as 20% to 40% by weight, such as 30% to 40% by weight, such as 0.1% to 30% by weight, such as 5% to 30% by weight, such as 10% to 30% by weight, such as 20% to 30% by weight, such as 0.1% to 20% by weight, such as 5% to 20% by weight, such as 10% to 20% by weight, such as 0.1% to 10% by weight, such as 5% to 10% by weight, based on the total weight of the solvent system.

The ester may be present in the solvent system in an amount of at least 0.1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, such as at least 95% by weight, such as at least 99% by weight, based on the total weight of the solvent system. The ester may be present in the solvent system in an amount of no more than 99.9% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the solvent system. The ester may be present in the solvent system in an amount of 0.1% to 99.9% by weight, such as 5% to 99.9% by weight, such as 10% to 99.9% by weight, such as 20% to 99.9% by weight, such as 30% to 99.9% by weight, such as 40% to 99.9% by weight, such as 50% to 99.9% by weight, such as 60% to 99.9% by weight, such as 70% to 99.9% by weight, such as 80% to 99.9% by weight, such as 90% to 99.9% by weight, such as 95% to 99.9% by weight, such as 5% to 95% by weight, such as 5% to 95% by weight, such as 10% to 95% by weight, such as 20% to 95% by weight, such as 30% to 95% by weight, such as 40% to 95% by weight, such as 50% to 95% by weight, such as 60% to 95% by weight, such as 70% to 95% by weight, such as 80% to 95% by weight, such as 90% to 95% by weight, such as 0.1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as such as 0.1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.1% to 50% by weight, such as 5% to 50% by weight, such as 10% to 50% by weight, such as 20% to 50% by weight, such as 30% to 50% by weight, such as 40% to 50% by weight, such as 0.1% to 40% by weight, such as 5% to 40% by weight, such as 10% to 40% by weight, such as 20% to 40% by weight, such as 30% to 40% by weight, such as 0.1% to 30% by weight, such as 5% to 30% by weight, such as 10% to 30% by weight, such as 20% to 30% by weight, such as 0.1% to 20% by weight, such as 5% to 20% by weight, such as 10% to 20% by weight, such as 0.1% to 10% by weight, such as 5% to 10% by weight, based on the total weight of the solvent system.

The fluoropolymer of the slurry composition may be solubilized in the solvent system at room temperature, i.e., about 23° C., and pressure.

The solvent may include less than 1% by weight of a molecule comprising the structure R¹C(═O)NR²R³, wherein R¹ is an aliphatic saturated group, that can be linear or branched, having 1 to 6 carbon atoms, and substituted by one or more functional groups comprising —C(═O)OR and —C(═O)NR⁴R⁵, R being an alkyl group having 1 to 6 carbon atoms, and R⁴ and R⁵ each independently are methyl or ethyl groups, and R² and R³ each independently are methyl or ethyl groups, based on the weight of the solvent system.

The solvent system may also be substantially free, essentially free, or completely free of a molecule comprising the structure R¹C(═O)NR²R³, wherein R¹ is an aliphatic saturated group, that can be linear or branched, having 1 to 6 carbon atoms, and substituted by one or more functional groups comprising —C(═O)OR and —C(═O)NR⁴R⁵, R being an alkyl group having 1 to 6 carbon atoms, and R⁴ and R⁵ each independently are methyl or ethyl groups, and R² and R³ each independently are methyl or ethyl groups. The solvent system is substantially free of the molecule if the molecule is present, if at all, in an amount of less than 0.5% by weight, based on the weight of the solvent system. The solvent system is essentially free of the molecule if the molecule is present, if at all, in an amount of less than 0.1% by weight, based on the weight of the solvent system. The solvent system is completely free of the molecule if the molecule is not present, i.e., 0.00% by weight.

As mentioned above, the organic medium may comprise a solvent system comprising (i) a trialkyl phosphate; and (ii) a co-solvent comprising a lactone and/or a molecule comprising a sulfoxide and/or sulfone functional group, wherein the trialkyl phosphate and the co-solvent comprise at least 50% by weight of the solvent system, based on the total weight of the solvent system.

As used herein, the term “solvent system” refers to the combination of solvents used in the composition. The solvent system of the present disclosure may comprise, consist essentially of, or consist of (i) a trialkyl phosphate, and (ii) a co-solvent comprising a lactone and/or a molecule comprising a sulfoxide and/or sulfone functional group.

The trialkyl phosphate may comprise any suitable trialkyl phosphate. For example, the trialkyl phosphate may comprise, consist essentially of, or consist of trimethyl phosphate, triethyl phosphate, tributyl phosphate, or any combination thereof.

The lactone may comprise any suitable lactone. For example, the lactone may comprise, consist essentially of, or consist of ε-caprolactone, γ-butyrolactone, or any combination thereof.

The molecule comprising a sulfoxide functional group may comprise any suitable molecule comprising a sulfoxide functional group. For example, the molecule comprising a sulfoxide functional group may comprise dimethyl sulfoxide.

The molecule comprising a sulfone functional group may comprise any suitable molecule comprising a sulfone functional group. For example, the molecule comprising a sulfone functional group may comprise tetramethylene sulfone (also known as sulfolane).

The trialkyl phosphate may be present in the solvent system in an amount of at least 0.1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, such as at least 95% by weight, such as at least 99% by weight, based on the total weight of the solvent system. The trialkyl phosphate may be present in the solvent system in an amount of no more than 99.9% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the solvent system. The trialkyl phosphate may be present in the solvent system in an amount of 0.1% to 99.9% by weight, such as 5% to 99.9% by weight, such as 10% to 99.9% by weight, such as 20% to 99.9% by weight, such as 30% to 99.9% by weight, such as 40% to 99.9% by weight, such as 50% to 99.9% by weight, such as 60% to 99.9% by weight, such as 70% to 99.9% by weight, such as 80% to 99.9% by weight, such as 90% to 99.9% by weight, such as 95% to 99.9% by weight, such as 5% to 95% by weight, such as 5% to 95% by weight, such as 10% to 95% by weight, such as 20% to 95% by weight, such as 30% to 95% by weight, such as 40% to 95% by weight, such as 50% to 95% by weight, such as 60% to 95% by weight, such as 70% to 95% by weight, such as 80% to 95% by weight, such as 90% to 95% by weight, such as 0.1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as such as 0.1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.1% to 50% by weight, such as 5% to 50% by weight, such as 10% to 50% by weight, such as 20% to 50% by weight, such as 30% to 50% by weight, such as 40% to 50% by weight, such as 0.1% to 40% by weight, such as 5% to 40% by weight, such as 10% to 40% by weight, such as 20% to 40% by weight, such as 30% to 40% by weight, such as 0.1% to 30% by weight, such as 5% to 30% by weight, such as 10% to 30% by weight, such as 20% to 30% by weight, such as 0.1% to 20% by weight, such as 5% to 20% by weight, such as 10% to 20% by weight, such as 0.1% to 10% by weight, such as 5% to 10% by weight, based on the total weight of the solvent system.

The lactone may be present in the solvent system in an amount of at least 0.1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, such as at least 95% by weight, such as at least 99% by weight, based on the total weight of the solvent system. The lactone may be present in the solvent system in an amount of no more than 99.9% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the solvent system. The lactone may be present in the solvent system in an amount of 0.1% to 99.9% by weight, such as 5% to 99.9% by weight, such as 10% to 99.9% by weight, such as 20% to 99.9% by weight, such as 30% to 99.9% by weight, such as 40% to 99.9% by weight, such as 50% to 99.9% by weight, such as 60% to 99.9% by weight, such as 70% to 99.9% by weight, such as 80% to 99.9% by weight, such as 90% to 99.9% by weight, such as 95% to 99.9% by weight, such as 5% to 95% by weight, such as 5% to 95% by weight, such as 10% to 95% by weight, such as 20% to 95% by weight, such as 30% to 95% by weight, such as 40% to 95% by weight, such as 50% to 95% by weight, such as 60% to 95% by weight, such as 70% to 95% by weight, such as 80% to 95% by weight, such as 90% to 95% by weight, such as 0.1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as such as 0.1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.1% to 50% by weight, such as 5% to 50% by weight, such as 10% to 50% by weight, such as 20% to 50% by weight, such as 30% to 50% by weight, such as 40% to 50% by weight, such as 0.1% to 40% by weight, such as 5% to 40% by weight, such as 10% to 40% by weight, such as 20% to 40% by weight, such as 30% to 40% by weight, such as 0.1% to 30% by weight, such as 5% to 30% by weight, such as 10% to 30% by weight, such as 20% to 30% by weight, such as 0.1% to 20% by weight, such as 5% to 20% by weight, such as 10% to 20% by weight, such as 0.1% to 10% by weight, such as 5% to 10% by weight, based on the total weight of the solvent system.

The molecule comprising a sulfoxide and/or sulfone functional group may be present in the solvent system in an amount of at least 0.1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, such as at least 95% by weight, such as at least 99% by weight, based on the total weight of the solvent system. The molecule comprising a sulfoxide and/or sulfone functional group may be present in the solvent system in an amount of no more than 99.9% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the solvent system. The molecule comprising a sulfoxide and/or sulfone functional group may be present in the solvent system in an amount of 0.1% to 99.9% by weight, such as 5% to 99.9% by weight, such as 10% to 99.9% by weight, such as 20% to 99.9% by weight, such as 30% to 99.9% by weight, such as 40% to 99.9% by weight, such as 50% to 99.9% by weight, such as 60% to 99.9% by weight, such as 70% to 99.9% by weight, such as 80% to 99.9% by weight, such as 90% to 99.9% by weight, such as 95% to 99.9% by weight, such as 5% to 95% by weight, such as 5% to 95% by weight, such as 10% to 95% by weight, such as 20% to 95% by weight, such as 30% to 95% by weight, such as 40% to 95% by weight, such as 50% to 95% by weight, such as 60% to 95% by weight, such as 70% to 95% by weight, such as 80% to 95% by weight, such as 90% to 95% by weight, such as 0.1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as such as 0.1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.1% to 50% by weight, such as 5% to 50% by weight, such as 10% to 50% by weight, such as 20% to 50% by weight, such as 30% to 50% by weight, such as 40% to 50% by weight, such as 0.1% to 40% by weight, such as 5% to 40% by weight, such as 10% to 40% by weight, such as 20% to 40% by weight, such as 30% to 40% by weight, such as 0.1% to 30% by weight, such as 5% to 30% by weight, such as 10% to 30% by weight, such as 20% to 30% by weight, such as 0.1% to 20% by weight, such as 5% to 20% by weight, such as 10% to 20% by weight, such as 0.1% to 10% by weight, such as 5% to 10% by weight, based on the total weight of the solvent system.

The molecule comprising a sulfoxide functional group may be present in the solvent system in an amount of at least 0.1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, such as at least 95% by weight, such as at least 99% by weight, based on the total weight of the solvent system. The molecule comprising a sulfoxide functional group may be present in the solvent system in an amount of no more than 99.9% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the solvent system. The molecule comprising a sulfoxide functional group may be present in the solvent system in an amount of 0.1% to 99.9% by weight, such as 5% to 99.9% by weight, such as 10% to 99.9% by weight, such as 20% to 99.9% by weight, such as 30% to 99.9% by weight, such as 40% to 99.9% by weight, such as 50% to 99.9% by weight, such as 60% to 99.9% by weight, such as 70% to 99.9% by weight, such as 80% to 99.9% by weight, such as 90% to 99.9% by weight, such as 95% to 99.9% by weight, such as 5% to 95% by weight, such as 5% to 95% by weight, such as 10% to 95% by weight, such as 20% to 95% by weight, such as 30% to 95% by weight, such as 40% to 95% by weight, such as 50% to 95% by weight, such as 60% to 95% by weight, such as 70% to 95% by weight, such as 80% to 95% by weight, such as 90% to 95% by weight, such as 0.1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as such as 0.1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.1% to 50% by weight, such as 5% to 50% by weight, such as 10% to 50% by weight, such as 20% to 50% by weight, such as 30% to 50% by weight, such as 40% to 50% by weight, such as 0.1% to 40% by weight, such as 5% to 40% by weight, such as 10% to 40% by weight, such as 20% to 40% by weight, such as 30% to 40% by weight, such as 0.1% to 30% by weight, such as 5% to 30% by weight, such as 10% to 30% by weight, such as 20% to 30% by weight, such as 0.1% to 20% by weight, such as 5% to 20% by weight, such as 10% to 20% by weight, such as 0.1% to 10% by weight, such as 5% to 10% by weight, based on the total weight of the solvent system.

The molecule comprising a sulfone functional group may be present in the solvent system in an amount of at least 0.1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, such as at least 95% by weight, such as at least 99% by weight, based on the total weight of the solvent system. The molecule comprising a sulfone functional group may be present in the solvent system in an amount of no more than 99.9% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the solvent system. The molecule comprising a sulfone functional group may be present in the solvent system in an amount of 0.1% to 99.9% by weight, such as 5% to 99.9% by weight, such as 10% to 99.9% by weight, such as 20% to 99.9% by weight, such as 30% to 99.9% by weight, such as 40% to 99.9% by weight, such as 50% to 99.9% by weight, such as 60% to 99.9% by weight, such as 70% to 99.9% by weight, such as 80% to 99.9% by weight, such as 90% to 99.9% by weight, such as 95% to 99.9% by weight, such as 5% to 95% by weight, such as 5% to 95% by weight, such as 10% to 95% by weight, such as 20% to 95% by weight, such as 30% to 95% by weight, such as 40% to 95% by weight, such as 50% to 95% by weight, such as 60% to 95% by weight, such as 70% to 95% by weight, such as 80% to 95% by weight, such as 90% to 95% by weight, such as 0.1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as such as 0.1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.1% to 50% by weight, such as 5% to 50% by weight, such as 10% to 50% by weight, such as 20% to 50% by weight, such as 30% to 50% by weight, such as 40% to 50% by weight, such as 0.1% to 40% by weight, such as 5% to 40% by weight, such as 10% to 40% by weight, such as 20% to 40% by weight, such as 30% to 40% by weight, such as 0.1% to 30% by weight, such as 5% to 30% by weight, such as 10% to 30% by weight, such as 20% to 30% by weight, such as 0.1% to 20% by weight, such as 5% to 20% by weight, such as 10% to 20% by weight, such as 0.1% to 10% by weight, such as 5% to 10% by weight, based on the total weight of the solvent system.

The trialkyl phosphate and the co-solvent combined may comprise at least 50% by weight of the solvent system, such as at least 60% by weight, such as at least 70% by weight, such as at least 80% by weight, such as at least 90% by weight, such as at least 95% by weight, such as 100% by weight, based on the total weight of the solvent system.

The trialkyl phosphate and the lactone combined may comprise at least 50% by weight of the solvent system, such as at least 60% by weight, such as at least 70% by weight, such as at least 80% by weight, such as at least 90% by weight, such as at least 95% by weight, such as 100% by weight, based on the total weight of the solvent system.

The trialkyl phosphate and the molecule comprising a sulfoxide and/or sulfone functional group combined may comprise at least 50% by weight of the solvent system, such as at least 60% by weight, such as at least 70% by weight, such as at least 80% by weight, such as at least 90% by weight, such as at least 95% by weight, such as 100% by weight, based on the total weight of the solvent system.

The trialkyl phosphate and the molecule comprising a sulfoxide functional group combined may comprise at least 50% by weight of the solvent system, such as at least 60% by weight, such as at least 70% by weight, such as at least 80% by weight, such as at least 90% by weight, such as at least 95% by weight, such as 100% by weight, based on the total weight of the solvent system.

The trialkyl phosphate and the molecule comprising a sulfone functional group combined may comprise at least 50% by weight of the solvent system, such as at least 60% by weight, such as at least 70% by weight, such as at least 80% by weight, such as at least 90% by weight, such as at least 95% by weight, such as 100% by weight, based on the total weight of the solvent system.

The organic medium may be present in an amount of at least 10% by weight, such as at least 15% by weight, such as at least 18% by weight, such as at least 20% by weight, such as at least 24% by weight, such as at least 25% by weight, such as at least 28% by weight, such as at least 30% by weight, such as at least 32% by weight, such as at least 35% by weight, such as at least 38% by weight, such as at least 40% by weight, such as at least 42% by weight, such as at least 45% by weight, such as at least 48% by weight, such as at least 50% by weight, such as at least 55% by weight, such as at least 60% by weight, such as at least 65% by weight, such as at least 70% by weight, based on the total weight of the slurry composition. The organic medium may be present in an amount of no more than 90% by weight, such as no more than 85% by weight, such as no more than 82% by weight, such as no more than 80% by weight, such as no more than 76% by weight, such as no more than 75% by weight, such as no more than 72% by weight, such as no more than 70% by weight, such as no more than 68% by weight, such as no more than 65% by weight, such as no more than 62% by weight, such as no more than 60% by weight, such as no more than 58% by weight, such as no more than 55% by weight, such as no more than 52% by weight, such as no more than 50% by weight, such as no more than 45% by weight, such as no more than 40% by weight, such as no more than 35% by weight, such as no more than 30% by weight, based on the total weight of the slurry composition. The organic medium may be present in an amount of such as 10% to 90% by weight, such as 10% to 85% by weight, such as 10% to 82% by weight, such as 10% to 80% by weight, such as 10% to 76% by weight, such as 10% to 75% by weight, such as 10% to 72% by weight, such as 10% to 70% by weight, such as 10% to 68% by weight, such as 10% to 65% by weight, such as 10% to 62% by weight, such as 10% to 60% by weight, such as 10% to 58% by weight, such as 10% to 55% by weight, such as 10% to 52% by weight, such as 10% to 50% by weight, such as 10% to 45% by weight, such as 10% to 40% by weight, such as 10% to 35% by weight, such as 10% to 30% by weight, such as 15% to 90% by weight, such as 15% to 85% by weight, such as 15% to 82% by weight, such as 15% to 80% by weight, such as 15% to 76% by weight, such as 15% to 75% by weight, such as 15% to 72% by weight, such as 15% to 70% by weight, such as 15% to 68% by weight, such as 15% to 65% by weight, such as 15% to 62% by weight, such as 15% to 60% by weight, such as 15% to 58% by weight, such as 15% to 55% by weight, such as 15% to 52% by weight, such as 15% to 50% by weight, such as 15% to 45% by weight, such as 15% to 40% by weight, such as 15% to 35% by weight, such as 15% to 30% by weight, such as 18% to 90% by weight, such as 18% to 85% by weight, such as 18% to 82% by weight, such as 18% to 80% by weight, such as 18% to 76% by weight, such as 18% to 75% by weight, such as 18% to 72% by weight, such as 18% to 70% by weight, such as 18% to 68% by weight, such as 18% to 65% by weight, such as 18% to 62% by weight, such as 18% to 60% by weight, such as 18% to 58% by weight, such as 18% to 55% by weight, such as 18% to 52% by weight, such as 18% to 50% by weight, such as 18% to 45% by weight, such as 18% to 40% by weight, such as 18% to 35% by weight, such as 18% to 30% by weight, such as 20% to 90% by weight, such as 20% to 85% by weight, such as 20% to 82% by weight, such as 20% to 80% by weight, such as 20% to 76% by weight, such as 20% to 75% by weight, such as 20% to 72% by weight, such as 20% to 70% by weight, such as 20% to 68% by weight, such as 20% to 65% by weight, such as 20% to 62% by weight, such as 20% to 60% by weight, such as 20% to 58% by weight, such as 20% to 55% by weight, such as 20% to 52% by weight, such as 20% to 50% by weight, such as 20% to 45% by weight, such as 20% to 40% by weight, such as 20% to 35% by weight, such as 20% to 30% by weight, such as 24% to 90% by weight, such as 24% to 85% by weight, such as 24% to 82% by weight, such as 24% to 80% by weight, such as 24% to 76% by weight, such as 24% to 75% by weight, such as 24% to 72% by weight, such as 24% to 70% by weight, such as 24% to 68% by weight, such as 24% to 65% by weight, such as 24% to 62% by weight, such as 24% to 60% by weight, such as 24% to 58% by weight, such as 24% to 55% by weight, such as 24% to 52% by weight, such as 24% to 50% by weight, such as 24% to 45% by weight, such as 24% to 40% by weight, such as 24% to 35% by weight, such as 24% to 30% by weight, such as 25% to 90% by weight, such as 25% to 85% by weight, such as 25% to 82% by weight, such as 25% to 80% by weight, such as 25% to 76% by weight, such as 25% to 75% by weight, such as 25% to 72% by weight, such as 25% to 70% by weight, such as 25% to 68% by weight, such as 25% to 65% by weight, such as 25% to 62% by weight, such as 25% to 60% by weight, such as 25% to 58% by weight, such as 25% to 55% by weight, such as 25% to 52% by weight, such as 25% to 50% by weight, such as 25% to 45% by weight, such as 25% to 40% by weight, such as 25% to 35% by weight, such as 25% to 30% by weight, such as 28% to 90% by weight, such as 28% to 85% by weight, such as 28% to 82% by weight, such as 28% to 80% by weight, such as 28% to 76% by weight, such as 28% to 75% by weight, such as 28% to 72% by weight, such as 28% to 70% by weight, such as 28% to 68% by weight, such as 28% to 65% by weight, such as 28% to 62% by weight, such as 28% to 60% by weight, such as 28% to 58% by weight, such as 28% to 55% by weight, such as 28% to 52% by weight, such as 28% to 50% by weight, such as 28% to 45% by weight, such as 28% to 40% by weight, such as 28% to 35% by weight, such as 28% to 30% by weight, such as 30% to 90% by weight, such as 30% to 85% by weight, such as 30% to 82% by weight, such as 30% to 80% by weight, such as 30% to 76% by weight, such as 30% to 75% by weight, such as 30% to 72% by weight, such as 30% to 70% by weight, such as 30% to 68% by weight, such as 30% to 65% by weight, such as 30% to 62% by weight, such as 30% to 60% by weight, such as 30% to 58% by weight, such as 30% to 55% by weight, such as 30% to 52% by weight, such as 30% to 50% by weight, such as 30% to 45% by weight, such as 30% to 40% by weight, such as 30% to 35% by weight, such as 35% to 90% by weight, such as 35% to 85% by weight, such as 35% to 82% by weight, such as 35% to 80% by weight, such as 35% to 76% by weight, such as 35% to 75% by weight, such as 35% to 72% by weight, such as 35% to 70% by weight, such as 35% to 68% by weight, such as 35% to 65% by weight, such as 35% to 62% by weight, such as 35% to 60% by weight, such as 35% to 58% by weight, such as 35% to 55% by weight, such as 35% to 52% by weight, such as 35% to 50% by weight, such as 35% to 45% by weight, such as 35% to 40% by weight, such as 38% to 90% by weight, such as 38% to 85% by weight, such as 38% to 82% by weight, such as 38% to 80% by weight, such as 38% to 76% by weight, such as 38% to 75% by weight, such as 38% to 72% by weight, such as 38% to 70% by weight, such as 38% to 68% by weight, such as 38% to 65% by weight, such as 38% to 62% by weight, such as 38% to 60% by weight, such as 38% to 58% by weight, such as 38% to 55% by weight, such as 38% to 52% by weight, such as 38% to 50% by weight, such as 38% to 45% by weight, such as 38% to 40% by weight, such as 40% to 90% by weight, such as 40% to 85% by weight, such as 40% to 82% by weight, such as 40% to 80% by weight, such as 40% to 76% by weight, such as 40% to 75% by weight, such as 40% to 72% by weight, such as 40% to 70% by weight, such as 40% to 68% by weight, such as 40% to 65% by weight, such as 40% to 62% by weight, such as 40% to 60% by weight, such as 40% to 58% by weight, such as 40% to 55% by weight, such as 40% to 52% by weight, such as 40% to 50% by weight, such as 40% to 45% by weight, such as 42% to 90% by weight, such as 42% to 85% by weight, such as 42% to 82% by weight, such as 42% to 80% by weight, such as 42% to 76% by weight, such as 42% to 75% by weight, such as 42% to 72% by weight, such as 42% to 70% by weight, such as 42% to 68% by weight, such as 42% to 65% by weight, such as 42% to 62% by weight, such as 42% to 60% by weight, such as 42% to 58% by weight, such as 42% to 55% by weight, such as 42% to 52% by weight, such as 42% to 50% by weight, such as 42% to 45% by weight, such as 45% to 90% by weight, such as 45% to 85% by weight, such as 45% to 82% by weight, such as 45% to 80% by weight, such as 45% to 76% by weight, such as 45% to 75% by weight, such as 45% to 72% by weight, such as 45% to 70% by weight, such as 45% to 68% by weight, such as 45% to 65% by weight, such as 45% to 62% by weight, such as 45% to 60% by weight, such as 45% to 58% by weight, such as 45% to 55% by weight, such as 45% to 52% by weight, such as 45% to 50% by weight, such as 48% to 90% by weight, such as 48% to 85% by weight, such as 48% to 82% by weight, such as 48% to 80% by weight, such as 48% to 76% by weight, such as 48% to 75% by weight, such as 48% to 72% by weight, such as 48% to 70% by weight, such as 48% to 68% by weight, such as 48% to 65% by weight, such as 48% to 62% by weight, such as 48% to 60% by weight, such as 48% to 58% by weight, such as 48% to 55% by weight, such as 48% to 52% by weight, such as 48% to 50% by weight, such as 50% to 90% by weight, such as 50% to 85% by weight, such as 50% to 82% by weight, such as 50% to 80% by weight, such as 50% to 76% by weight, such as 50% to 75% by weight, such as 50% to 72% by weight, such as 50% to 70% by weight, such as 50% to 68% by weight, such as 50% to 65% by weight, such as 50% to 62% by weight, such as 50% to 60% by weight, such as 50% to 58% by weight, such as 50% to 55% by weight, such as 50% to 52% by weight, such as 55% to 90% by weight, such as 55% to 85% by weight, such as 55% to 82% by weight, such as 55% to 80% by weight, such as 55% to 76% by weight, such as 55% to 75% by weight, such as 55% to 72% by weight, such as 55% to 70% by weight, such as 55% to 68% by weight, such as 55% to 65% by weight, such as 55% to 62% by weight, such as 55% to 60% by weight, such as 55% to 58% by weight, such as 60% to 90% by weight, such as 60% to 85% by weight, such as 60% to 82% by weight, such as 60% to 80% by weight, such as 60% to 76% by weight, such as 60% to 75% by weight, such as 60% to 72% by weight, such as 60% to 70% by weight, such as 60% to 68% by weight, such as 60% to 65% by weight, such as 60% to 62% by weight, such as 65% to 90% by weight, such as 65% to 85% by weight, such as 65% to 82% by weight, such as 65% to 80% by weight, such as 65% to 76% by weight, such as 65% to 75% by weight, such as 65% to 72% by weight, such as 65% to 70% by weight, such as 65% to 68% by weight, such as 70% to 90% by weight, such as 70% to 85% by weight, such as 70% to 82% by weight, such as 70% to 80% by weight, such as 70% to 76% by weight, such as 70% to 75% by weight, such as 70% to 72% by weight, based on the total weight of the slurry composition.

The battery electrode slurry composition may be substantially free, essentially free, or completely free of N-Methyl-2-pyrrolidone (NMP). As used herein, the battery electrode slurry composition is “substantially free” of NMP if NMP is present, if at all, in an amount of less than 5% by weight, based on the total weight of the battery electrode slurry composition. As used herein, the battery electrode slurry composition is “essentially free” of NMP if NMP is present, if at all, in an amount of less than 0.3% by weight, based on the total weight of the battery electrode slurry composition. As used herein, the battery electrode slurry composition is “completely free” of NMP if NMP is not present in the slurry composition, i.e., 0.0% by weight, based on the total weight of the battery electrode slurry composition.

The slurry composition may be substantially free, essentially free, or completely free of ketones such as methyl ethyl ketone, cyclohexanone, isophorone, acetophenone.

The slurry composition may be substantially free, essentially free, or completely free of ethers such as the C₁ to C₄ alkyl ethers of ethylene or propylene glycol.

According to the present disclosure, the binder of the battery electrode slurry composition comprises a fluoropolymer dispersed or solubilized in an organic medium. The fluoropolymer may serve as all or a component of the binder for the battery electrode slurry composition.

The fluoropolymer may comprise a (co) polymer comprising the residue of vinylidene fluoride. A non-limiting example of a (co) polymer comprising the residue of vinylidene fluoride is a polyvinylidene fluoride polymer (PVDF). As used herein, the “polyvinylidene fluoride polymer” includes homopolymers, copolymers, such as binary copolymers, and terpolymers, including high molecular weight homopolymers, copolymers, and terpolymers. Such (co) polymers include those containing at least 50 mole percent, such as at least 75 mole %, and at least 80 mole %, and at least 85 mole % of the residue of vinylidene fluoride (also known as vinylidene difluoride). The vinylidene fluoride monomer may be copolymerized with at least one comonomer selected from the group consisting of tetrafluoroethylene, trifluoroethylene, chlorotrifluoroethylene, hexafluoropropene, vinyl fluoride, pentafluoropropene, tetrafluoropropene, perfluoromethyl vinyl ether, perfluoropropyl vinyl ether and any other monomer that would readily copolymerize with vinylidene fluoride in order to produce the fluoropolymer of the present disclosure. The fluoropolymer may also comprise a PVDF homopolymer.

The polyvinylidene fluoride may comprise a polyvinylidene fluoride copolymer comprising constitutional units comprising the residue of vinylidene fluoride and at least one of (i) a (meth)acrylic acid; and/or (ii) a hydroxyalkyl (meth)acrylate. The (meth)acrylic acid may comprise acrylic acid, methacrylic acid, or combinations thereof. The hydroxyalkyl (meth)acrylate may comprise a C₁ to C₅ hydroxyalkyl (meth)acrylate, such as, for example, hydroxyethyl (meth)acrylate, 2-hydroxypropyl (meth)acrylate, 2-hydroxybutyl (meth)acrylate, or combinations thereof. A commercially available example of such a polyvinylidene fluoride copolymer includes SOLEF 5130, available from Solvay.

The fluoropolymer may have a weight average molecular weight of at least 50,000 g/mol, such as at least 100,000 g/mol, such as at least 250,000 g/mol, such as at least 300,000 g/mol, such as at least 350,000 g/mol, such as at least 400,000 g/mol, such as at least 450,000 g/mol, such as at least 500,000 g/mol, such as at least 550,000 g/mol, such as 600,000 g/mol, such as at least 650,000 g/mol, such as at least 700,000 g/mol, such as at least 750,000 g/mol, such as at least 800,000 g/mol, such as at least 850,000 g/mol, such as at least 900,000 g/mol, such as at least 950,000 g/mol, such as at least 1,000,000 g/mol, such as at least 1,050,000 g/mol, such as at least 1,100,000 g/mol, such as at least 1,150,000 g/mol, such as at least 1,200,000 g/mol, such as at least 1,250,000 g/mol. The fluoropolymer may have a weight average molecular weight of no more than 1,500,000 g/mol, such as no more than 1,250,000 g/mol, such as no more than 1,200,000 g/mol, such as no more than 1,150,000 g/mol, such as no more than 1,100,000 g/mol, such as no more than 1,050,000 g/mol, such as no more than 1,000,000 g/mol, such as no more than 950,000 g/mol, such as no more than 900,000 g/mol, such as no more than 850,000 g/mol, such as no more than 800,000 g/mol, such as no more than 750,000 g/mol, such as no more than 700,000 g/mol, such as no more than 650,000 g/mol, such as no more than 600,000 g/mol, such as no more than 550,000 g/mol, such as no more than 500,000 g/mol, such as no more than 450,000 g/mol, such as no more than 400,000 g/mol, such as no more than 350,000 g/mol, such as no more than 300,000 g/mol. The fluoropolymer may have a weight average molecular weight of 50,000 to 1,500,000 g/mol, such as 250,000 to 700,000 g/mol, such as 250,000 to 650,000 g/mol, such as 250,000 to 600,000 g/mol, such as 250,000 to 550,000 g/mol, such as 250,000 to 500,000 g/mol, such as 250,000 to 450,000 g/mol, such as 250,000 to 400,000 g/mol, such as 250,000 to 350,000 g/mol, such as 250,000 to 300,000 g/mol, such as 300,000 to 700,000 g/mol, such as 300,000 to 650,000 g/mol, such as 300,000 to 600,000 g/mol, such as 300,000 to 550,000 g/mol, such as 300,000 to 500,000 g/mol, such as 300,000 to 450,000 g/mol, such as 300,000 to 400,000 g/mol, such as 300,000 to 350,000 g/mol, such as such as 350,000 to 700,000 g/mol, such as 350,000 to 650,000 g/mol, such as 350,000 to 600,000 g/mol, such as 350,000 to 550,000 g/mol, such as 350,000 to 500,000 g/mol, such as 350,000 to 450,000 g/mol, such as 350,000 to 400,000 g/mol, such as 400,000 to 700,000 g/mol, such as 400,000 to 650,000 g/mol, such as 400,000 to 600,000 g/mol, such as 400,000 to 550,000 g/mol, such as 400,000 to 500,000 g/mol, such as 400,000 to 450,000 g/mol, such as 450,000 to 700,000 g/mol, such as 450,000 to 650,000 g/mol, such as 450,000 to 600,000 g/mol, such as 450,000 to 550,000 g/mol, such as 450,000 to 500,000 g/mol, such as 500,000 to 700,000 g/mol, such as 500,000 to 650,000 g/mol, such as 500,000 to 600,000 g/mol, such as 500,000 to 550,000 g/mol, such as 550,000 to 700,000 g/mol, such as 550,000 to 650,000 g/mol, such as 550,000 to 600,000 g/mol, such as 600,000 to 700,000 g/mol, such as 600,000 to 650,000 g/mol, such as 650,000 to 700,000 g/mol, such as 750,000 to 1,500,000 g/mol, such as 750,000 to 1,250,000 g/mol, such as 750,000 to 1,200,000 g/mol, such as 750,000 to 1,150,000 g/mol, such as 750,000 to 1,100,000 g/mol, such as 750,000 to 1,050,000 g/mol, such as 750,000 to 1,000,000 g/mol, such as 750,000 to 950,000 g/mol, such as 750,000 to 900,000 g/mol, such as 750,000 to 850,000 g/mol, such as 750,000 to 800,000 g/mol, such as 800,000 to 1,500,000 g/mol, such as 800,000 to 1,250,000 g/mol, such as 800,000 to 1,200,000 g/mol, such as 800,000 to 1,150,000 g/mol, such as 800,000 to 1,100,000 g/mol, such as 800,000 to 1,050,000 g/mol, such as 800,000 to 1,000,000 g/mol, such as 800,000 to 950,000 g/mol, such as 800,000 to 900,000 g/mol, such as 800,000 to 850,000 g/mol, such as 850,000 to 1,500,000 g/mol, such as 850,000 to 1,250,000 g/mol, such as 850,000 to 1,200,000 g/mol, such as 850,000 to 1,150,000 g/mol, such as 850,000 to 1,100,000 g/mol, such as 850,000 to 1,050,000 g/mol, such as 850,000 to 1,000,000 g/mol, such as 850,000 to 950,000 g/mol, such as 850,000 to 900,000 g/mol, such as 900,000 to 1,500,000 g/mol, such as 900,000 to 1,250,000 g/mol, such as 900,000 to 1,200,000 g/mol, such as 900,000 to 1,150,000 g/mol, such as 900,000 to 1,100,000 g/mol, such as 900,000 to 1,050,000 g/mol, such as 900,000 to 1,000,000 g/mol, such as 900,000 to 950,000 g/mol, such as 950,000 to 1,500,000 g/mol, such as 950,000 to 1,250,000 g/mol, such as 950,000 to 1,200,000 g/mol, such as 950,000 to 1,150,000 g/mol, such as 950,000 to 1,100,000 g/mol, such as 950,000 to 1,050,000 g/mol, such as 950,000 to 1,000,000 g/mol, such as 1,000,000 to 1,500,000 g/mol, such as 1,000,000 to 1,250,000 g/mol, such as 1,000,000 to 1,200,000 g/mol, such as 1,000,000 to 1,150,000 g/mol, such as 1,000,000 to 1,100,000 g/mol, such as 1,000,000 to 1,050,000 g/mol, such as 1,050,000 to 1,500,000 g/mol, such as 1,050,000 to 1,250,000 g/mol, such as 1,050,000 to 1,200,000 g/mol, such as 1,050,000 to 1,150,000 g/mol, such as 1,050,000 to 1,100,000 g/mol, such as 1,100,000 to 1,500,000 g/mol, such as 1,100,000 to 1,250,000 g/mol, such as 1,100,000 to 1,200,000 g/mol, such as 1,100,000 to 1,150,000 g/mol, such as 1,150,000 to 1,500,000 g/mol, such as 1,150,000 to 1,250,000 g/mol, such as 1,150,000 to 1,200,000 g/mol, such as 1,200,000 to 1,500,000 g/mol, such as 1,200,000 to 1,250,000 g/mol, such as 1,250,000 to 1,500,000 g/mol. A combination of fluoropolymers having different molecular weights may be used. PVDF is commercially available, e.g., from Arkema under the trademark KYNAR from Solvay under the trademark HYLAR, and from Inner Mongolia 3F Wanhao Fluorochemical Co., Ltd.

The fluoropolymer may comprise a nanoparticle. As used herein, the term “nanoparticle” refers to particles having a particle size of less than 1,000 nm. The fluoropolymer may have a particle size of at least 50 nm, such as at least 100 nm, such as at least 250 nm, such as at least 300 nm, and may be no more than 900 nm, such as no more than 600 nm, such as no more than 450 nm, such as no more than 400 nm, such as no more than 300 nm, such as no more than 200 nm. The fluoropolymer nanoparticles may have a particle size of 50 nm to 900 nm, such as 100 nm to 600 nm, such as 250 nm to 450 nm, such as 300 nm to 400 nm, such as 100 nm to 400 nm, such as 100 nm to 300 nm, such as 100 nm to 200 nm. As used herein, the term “particle size” refers to average diameter of the fluoropolymer particles. The particle size referred to in the present disclosure was determined by the following procedure: A sample was prepared by dispersing the fluoropolymer onto a segment of carbon tape that was attached to an aluminum scanning electron microscope (SEM) stub. Excess particles were blown off the carbon tape with compressed air. The sample was then sputter coated with Au/Pd for 20 seconds and was then analyzed in a Quanta 250 FEG SEM (field emission gun scanning electron microscope) under high vacuum. The accelerating voltage was set to 20.00 kV and the spot size was set to 3.0. Images were collected from three different areas on the prepared sample, and ImageJ software was used to measure the diameter of 10 fluoropolymer particles from each area for a total of 30 particle size measurements that were averaged together to determine the average particle size.

The fluoropolymer may be present in in the binder in amounts of at least 50% by weight, such as at least 60% by weight, such as at least 70% by weight, such as at least 80% by weight, such as at least 85% by weight, such as at least 90% by weight, such as at least 95% by weight, such as at least 98% by weight, based on the total weight of the binder solids. The fluoropolymer may be present in in the binder in amounts of no more than 99.9% by weight, such as no more than 99% by weight, such as no more than 98% by weight, such as no more than 96% by weight, such as no more than 95% by weight, such as no more than 90% by weight, such as no more than 85% by weight, such as no more than 80% by weight, based on the total weight of the binder solids. The fluoropolymer may be present in in the binder in amounts of 50% to 99.9% by weight, such as 50% to 99% by weight, such as 50% to 98% by weight, such as 50% to 96% by weight, such as 50% to 95% by weight, such as 50% to 90% by weight, such as 50% to 85% by weight, such as 50% to 80% by weight, such as 60% to 99.9% by weight, such as 60% to 99% by weight, such as 60% to 98% by weight, such as 60% to 96% by weight, such as 60% to 95% by weight, such as 60% to 90% by weight, such as 60% to 85% by weight, such as 60% to 80% by weight, such as 70% to 99.9% by weight, such as 70% to 99% by weight, such as 70% to 98% by weight, such as 70% to 96% by weight, such as 70% to 95% by weight, such as 70% to 90% by weight, such as 70% to 85% by weight, such as 70% to 80% by weight, such as 80% to 99.9% by weight, such as 80% to 99% by weight, such as 80% to 98% by weight, such as 80% to 96% by weight, such as 80% to 95% by weight, such as 80% to 90% by weight, such as 80% to 85% by weight, such as 85% to 99.9% by weight, such as 85% to 99% by weight, such as 85% to 98% by weight, such as 85% to 96% by weight, such as 85% to 95% by weight, such as 85% to 90% by weight, such as 90% to 99.9% by weight, such as 90% to 99% by weight, such as 90% to 98% by weight, such as 90% to 96% by weight, such as 95% to 99.9% by weight, such as 95% to 99% by weight, such as 95% to 98% by weight, such as 95% to 96% by weight, such as 98% to 99.9% by weight, such as 98% to 99% by weight, based on the total weight of the binder solids.

The fluoropolymer may be present in the slurry composition in an amount of at least 0.1% by weight, such as at least 0.5% by weight, such as at least 1% by weight, such as at least 1.3% by weight, such as at least 1.9% by weight, based on the total solids weight of the slurry composition. The fluoropolymer may be present in the slurry composition in an amount of no more than 10% by weight, such as no more than 6% by weight, such as no more than 4.5% by weight, such as no more than 2.9% by weight, such as no more than 2% by weight, based on the total solids weight of the slurry composition. The fluoropolymer may be present in the slurry composition in an amount of 0.1% to 10% by weight, such as 0.1% to 6% by weight, such as 0.1% to 4.5% by weight, such as 0.1% to 2.9% by weight, such as 0.1% to 2% by weight, such as 0.5% to 10% by weight, such as 0.5% to 6% by weight, such as 0.5% to 4.5% by weight, such as 0.5% to 2.9% by weight, such as 0.5% to 2% by weight, such as 1% to 10% by weight, such as 1% to 6% by weight, such as 1% to 4.5% by weight, such as 1% to 2.9% by weight, such as 1% to 2% by weight, such as 1.3% to 10% by weight, such as 1.3% to 6% by weight, such as 1.3% to 4.5% by weight, such as 1.3% to 2.9% by weight, such as 1.3% to 2% by weight, such as 1.9% to 10% by weight, such as 1.9% to 6% by weight, such as 1.9% to 4.5% by weight, such as 1.9% to 2.9% by weight, such as 1.9% to 2% by weight, based on the total solids weight of the slurry composition.

The slurry composition may optionally further comprise a dispersant. The dispersant may assist in dispersing the fluoropolymer (if dispersed), and/or, if present, the electrically conductive agent and/or the electrochemically active material in the organic medium. When present, the dispersant may be a component of the battery electrode slurry composition binder. The dispersant may comprise at least one phase that is compatible with the fluoropolymer and/or other components of the slurry composition, such as the electrically conductive agent or electrochemically active material, if present, and may further comprise at least one phase that is compatible with the organic medium. The battery electrode slurry composition may comprise one, two, three, four or more different dispersants, and each dispersant may assist in dispersing a different component of the slurry composition. The dispersant may comprise any material having phases compatible with both the fluoropolymer and/or, if present, the electrically conductive agent or electrochemically active material, and the organic medium. As used herein, the term “compatible” means the ability of a material to form a blend with other materials that is and will remain substantially homogenous over time. For example, the dispersant may comprise a polymer comprising such phases. The polymer may be in the form of a block polymer, a random polymer, or a gradient polymer, wherein the phases of present in the different blocks of the polymer, are randomly included throughout the polymer, or are progressively more or less densely present along the polymer backbone, respectively. The dispersant may comprise any suitable polymer to serve this purpose. For example, the polymer may comprise addition polymers produced by polymerizing ethylenically unsaturated monomers, polyepoxide polymers, polyamide polymers, polyurethane polymers, polyurea polymers, polyether polymers, polyacid polymers, and polyester polymers, among others. The dispersant may also serve as an additional component of the binder of the slurry composition. The fluoropolymer and dispersant may be separate components not be bound by a covalent bond.

The dispersant may comprise functional groups. The functional groups may comprise, for example, active hydrogen functional groups, heterocyclic groups, and combinations thereof. As used herein, the term “active hydrogen functional groups” refers to those groups that are reactive with isocyanates as determined by the Zerewitinoff test described in the JOURNAL OF THE AMERICAN CHEMICAL SOCIETY, Vol. 49, page 3181 (1927), and include, for example, hydroxyl groups, primary or secondary amino groups, carboxylic acid groups, and thiol groups. As used herein, the term “heterocyclic group” refers to a cyclic group containing at least two different elements in its ring such as a cyclic moiety having at least one atom in addition to carbon in the ring structure, such as, for example, oxygen, nitrogen, phosphorus, or sulfur. Non-limiting examples of heterocylic groups include epoxides, lactams and lactones. In addition, when epoxide functional groups are present on the addition polymer, the epoxide functional groups on the dispersant may be post-reacted with a beta-hydroxy functional acid. Non-limiting examples of beta-hydroxy functional acids include citric acid, tartaric acid, and/or an aromatic acid, such as 3-hydroxy-2-naphthoic acid. The ring opening reaction of the epoxide functional group will yield hydroxyl functional groups on the dispersant.

When acid functional groups are present, the dispersant may have a theoretical acid equivalent weight of at least 350 g/acid equivalent, such as at least 878 g/acid equivalent, such as at least 1,757 g/acid equivalent, and may be no more than 17,570 g/acid equivalent, such as no more than 12,000 g/acid equivalent, such as no more than 7,000 g/acid equivalent. The dispersant may have a theoretical acid equivalent weight of 350 to 17,570 g/acid equivalent, such as 878 to 12,000 g/acid equivalent, such as 1,757 to 7,000 g/acid equivalent.

As mentioned above, the dispersant may comprise an addition polymer. The addition polymer may be derived from, and comprise constitutional units comprising the residue of, one or more alpha, beta-ethylenically unsaturated monomers, such as those discussed below, and may be prepared by polymerizing a reaction mixture of such monomers. The mixture of monomers may comprise one or more active hydrogen group-containing ethylenically unsaturated monomers. The mixture of monomers may comprise one or more ethylenically unsaturated monomers comprising a silicon-containing functional group. The reaction mixture may also comprise ethylenically unsaturated monomers comprising a heterocyclic group. As used herein, an ethylenically unsaturated monomer comprising a heterocyclic group refers to a monomer having at least one alpha, beta ethylenic unsaturated group and at least cyclic moiety having at least one atom in addition to carbon in the ring structure, such as, for example, oxygen, nitrogen or sulfur. Non-limiting examples of ethylenically unsaturated monomers comprising a heterocyclic group include epoxy functional ethylenically unsaturated monomers, vinyl pyrrolidone and vinyl caprolactam, among others. The reaction mixture may additionally comprise other ethylenically unsaturated monomers such as alkyl esters of (meth)acrylic acid and others described below.

The addition polymer may comprise a (meth)acrylic polymer that comprises constitutional units comprising the residue of one or more (meth)acrylic monomers. The (meth)acrylic polymer may be prepared by polymerizing a reaction mixture of alpha, beta-ethylenically unsaturated monomers that comprise one or more (meth)acrylic monomers and optionally other ethylenically unsaturated monomers. As used herein, the term “(meth)acrylic monomer” refers to acrylic acid, methacrylic acid, and monomers derived therefrom, including alkyl esters of acrylic acid and methacrylic acid, and the like. As used herein, the term “(meth)acrylic polymer” refers to a polymer derived from or comprising constitutional units comprising the residue of one or more (meth)acrylic monomers. The mixture of monomers may comprise one or more active hydrogen group-containing (meth)acrylic monomers, ethylenically unsaturated monomers comprising a heterocyclic group, and other ethylenically unsaturated monomers. The (meth)acrylic polymer may also be prepared with an epoxy functional ethylenically unsaturated monomer such as glycidyl methacrylate in the reaction mixture, and epoxy functional groups on the resulting polymer may be post-reacted with a beta-hydroxy functional acid such as citric acid, tartaric acid, and/or 3-hydroxy-2-naphthoic acid to yield hydroxyl functional groups on the (meth)acrylic polymer.

The addition polymer may comprise constitutional units comprising the residue of an alpha, beta-ethylenically unsaturated carboxylic acid. Non-limiting examples of alpha, beta-ethylenically unsaturated carboxylic acids include those containing up to 10 carbon atoms such as acrylic acid and methacrylic acid. Non-limiting examples of other unsaturated acids are alpha, beta-ethylenically unsaturated dicarboxylic acids such as maleic acid or its anhydride, fumaric acid and itaconic acid. Also, the half esters of these dicarboxylic acids may be employed. The constitutional units comprising the residue of the alpha, beta-ethylenically unsaturated carboxylic acids may comprise at least 1% by weight, such as at least 2% by weight, such as at least 5% by weight, and may be no more than 50% by weight, such as no more than 20% by weight, such as no more than 10% by weight, such as no more than 5% by weight, based on the total weight of the addition polymer. The constitutional units comprising the residue of the alpha, beta-ethylenically unsaturated carboxylic acids may comprise 1% to 50% by weight, 2% to 50% by weight, such as 2% to 20% by weight, such as 2% to 10% by weight, such as 2% to 5% by weight, such as 1% to 5% by weight, based on the total weight of the addition polymer. The addition polymer may be derived from a reaction mixture comprising the alpha, beta-ethylenically unsaturated carboxylic acids in an amount of 1% to 50% by weight, 2% to 50% by weight, such as 2% to 20% by weight, such as 2% to 10% by weight, such as 2% to 5% by weight, such as 1% to 5% by weight, based on the total weight of polymerizable monomers used in the reaction mixture. The inclusion of constitutional units comprising the residue of an alpha, beta-ethylenically unsaturated carboxylic acids in the dispersant results in a dispersant comprising at least one carboxylic acid group which may assist in providing stability to the dispersion.

The addition polymer may comprise constitutional units comprising the residue of an alkyl esters of (meth)acrylic acid containing from 1 to 3 carbon atoms in the alkyl group. Non-limiting examples of alkyl esters of (meth)acrylic acid containing from 1 to 3 carbon atoms in the alkyl group include methyl (meth)acrylate and ethyl (meth)acrylate. The constitutional units comprising the residue of the alkyl esters of (meth)acrylic acid containing from 1 to 3 carbon atoms in the alkyl group may comprise at least 20% by weight, such as at least 30% by weight, such as at least 40% by weight, such as at least 45% by weight, such as at least 50% by weight, and may be no more than 98% by weight, such as no more than 96% by weight, such as no more than 90% by weight, such as no more than 80% by weight, such as no more than 75% by weight, based on the total weight of the addition polymer. The constitutional units comprising the residue of the alkyl esters of (meth)acrylic acid containing from 1 to 3 carbon atoms in the alkyl group may comprise 20% to 98% by weight, such as 30% to 96% by weight, such as 30% to 90% by weight, 40% to 90% by weight, such as 40% to 80% by weight, such as 45% to 75% by weight, based on the total weight of the addition polymer. The addition polymer may be derived from a reaction mixture comprising the alkyl esters of (meth)acrylic acid containing from 1 to 3 carbon atoms in the alkyl group in an amount of 20% to 98% by weight, such as 30% to 96% by weight, such as 30% to 90% by weight, 40% to 90% by weight, such as 40% to 80% by weight, such as 45% to 75% by weight, based on the total weight of polymerizable monomers used in the reaction mixture.

The addition polymer may comprise constitutional units comprising the residue of an alkyl esters of (meth)acrylic acid containing from 4 to 18 carbon atoms in the alkyl group. Non-limiting examples of alkyl esters of (meth)acrylic acid containing from 4 to 18 carbon atoms in the alkyl group include butyl (meth)acrylate, hexyl(meth)acrylate, octyl (meth)acrylate, isodecyl(meth)acrylate, stearyl (meth)acrylate, 2-ethylhexyl (meth)acrylate, decyl(meth)acrylate and dodecyl (meth)acrylate. The constitutional units comprising the residue of the alkyl esters of (meth)acrylic acid containing from 4 to 18 carbon atoms in the alkyl group may comprise at least 2% by weight, such as at least 5% by weight, such as at least 10% by weight, such as at least 15% by weight, such as at least 20% by weight, and may be no more than 70% by weight, such as no more than 60% by weight, such as no more than 50% by weight, such as no more than 40% by weight, such as no more than 35% by weight, based on the total weight of the addition polymer. The constitutional units comprising the residue of the alkyl esters of (meth)acrylic acid containing from 4 to 18 carbon atoms in the alkyl group may comprise 2% to 70% by weight, such as 2% to 60% by weight, such as 5% to 50% by weight, 10% to 40% by weight, such as 15% to 35% by weight, based on the total weight of the addition polymer. The addition polymer may be derived from a reaction mixture comprising the alkyl esters of (meth)acrylic acid containing from 4 to 18 carbon atoms in the alkyl group in an amount of 2% to 70% by weight, such as 2% to 60% by weight, such as 5% to 50% by weight, 10% to 40% by weight, such as 15% to 35% by weight, based on the total weight of polymerizable monomers used in the reaction mixture.

The addition polymer may comprise constitutional units comprising the residue of a hydroxyalkyl ester. Non-limiting examples of hydroxyalkyl esters include hydroxyethyl (meth)acrylate and hydroxypropyl (meth)acrylate. The constitutional units comprising the residue of the hydroxyalkyl ester may comprise at least 0.5% by weight, such as at least 1% by weight, such as at least 2% by weight, and may be no more than 30% by weight, such as no more than 20% by weight, such as no more than 10% by weight, such as no more than 5% by weight, based on the total weight of the addition polymer. The constitutional units comprising the residue of the hydroxyalkyl ester may comprise 0.5% to 30% by weight, such as 1% to 20% by weight, such as 2% to 20% by weight, 2% to 10% by weight, such as 2% to 5% by weight, based on the total weight of the addition polymer. The addition polymer may be derived from a reaction mixture comprising the hydroxyalkyl ester in an amount of 0.5% to 30% by weight, such as 1% to 20% by weight, such as 2% to 20% by weight, 2% to 10% by weight, such as 2% to 5% by weight, based on the total weight of polymerizable monomers used in the reaction mixture. The inclusion of constitutional units comprising the residue of a hydroxyalkyl ester in the dispersant results in a dispersant comprising at least one hydroxyl group (although hydroxyl groups may be included by other methods). Hydroxyl groups resulting from inclusion of the hydroxyalkyl esters (or incorporated by other means) may react with a separately added crosslinking agent that comprises functional groups reactive with hydroxyl groups such as, for example, an aminoplast, phenolplast, polyepoxides and blocked polyisocyanates, or with N-alkoxymethyl amide groups or blocked isocyanato groups present in the addition polymer when self-crosslinking monomers that have groups that are reactive with the hydroxyl groups are incorporated into the addition polymer.

The addition polymer may comprise constitutional units comprising the residue of an ethylenically unsaturated monomer comprising a heterocyclic group. Non-limiting examples of ethylenically unsaturated monomers comprising a heterocyclic group include epoxy functional ethylenically unsaturated monomers, such as glycidyl (meth)acrylate, vinyl pyrrolidone and vinyl caprolactam, among others. The constitutional units comprising the residue of the ethylenically unsaturated monomers comprising a heterocyclic group may comprise at least 0.5% by weight, such as at least 1% by weight, such as at least 5% by weight, such as at least 8% by weight, and may be no more than 99% by weight, such as no more than 50% by weight, such as no more than 40% by weight, such as no more than 30% by weight, such as no more than 27% by weight, based on the total weight of the addition polymer. The constitutional units comprising the residue of the ethylenically unsaturated monomers comprising a heterocyclic group may comprise 0.5% to 99% by weight, such as 0.5% to 50% by weight, such as 1% to 40% by weight, such as 5% to 30% by weight, 8% to 27% by weight, based on the total weight of the addition polymer. The addition polymer may be derived from a reaction mixture comprising the ethylenically unsaturated monomers comprising a heterocyclic group in an amount of 0.5% to 50% by weight, such as 1% to 40% by weight, such as 5% to 30% by weight, 8% to 27% by weight, based on the total weight of polymerizable monomers used in the reaction mixture.

As noted above, the addition polymer may comprise constitutional units comprising the residue of a self-crosslinking monomer, and the addition polymer may comprise a self-crosslinking addition polymer. As used herein, the term “self-crosslinking monomer” refers to monomers that incorporate functional groups that may react with other functional groups present on the dispersant to a crosslink between the dispersant or more than one dispersant. Non-limiting examples of self-crosslinking monomers include N-alkoxymethyl (meth)acrylamide monomers such as N-butoxymethyl (meth)acrylamide and N-isopropoxymethyl (meth)acrylamide. The constitutional units comprising the residue of the self-crosslinking monomer may comprise at least 0.5% by weight, such as at least 1% by weight, such as at least 2% by weight, and may be no more than 30% by weight, such as no more than 20% by weight, such as no more than 10% by weight, such as no more than 5% by weight, based on the total weight of the addition polymer. The constitutional units comprising the residue of the self-crosslinking monomer may comprise 0.5% to 30% by weight, such as 1% to 20% by weight, such as 2% to 20% by weight, 2% to 10% by weight, such as 2% to 5% by weight, based on the total weight of the addition polymer. The addition polymer may be derived from a reaction mixture comprising the self-crosslinking monomer in an amount of 0.5% to 30% by weight, such as 1% to 20% by weight, such as 2% to 20% by weight, 2% to 10% by weight, such as 2% to 5% by weight, based on the total weight of polymerizable monomers used in the reaction mixture.

The addition polymer may optionally comprise a silicon-containing functional group. As used herein, a “silicon-containing functional group” refers to an organosilicon group bound to the polymer backbone that comprises organic substituents. The silicon-containing functional group comprises at least one alkoxy substituent and may be represented by the general formula —SiR¹ₐX₃₋ₐ wherein R¹ represents a substituted or unsubstituted hydrocarbon group with 1 to 20 carbon atoms, each X independently represents a hydroxyl group or a hydrolysable group wherein at least one X is an alkoxy group, and a is 0, 1, or 2. Accordingly, the silicon-containing functional group may comprise one alkoxy substituent, two alkoxy substituents, three alkoxy substituents, or any combination thereof, and the addition polymer may comprise an ethylenically unsaturated monomer comprising a silicon-containing functional group comprising one alkoxy substituent, a silicon-containing functional group comprising two alkoxy substituents, a silicon-containing functional group comprising three alkoxy substituents, or any combination thereof.

The silicon-containing functional group may be included in the addition polymer as an ethylenically unsaturated monomer comprising a silicon-containing functional group included during polymerization of the addition polymer. The addition polymer may comprise constitutional units comprising the residue of an ethylenically unsaturated monomer comprising a silicon-containing functional group comprising at least one alkoxy substituent. The addition polymer may comprise constitutional units comprising the residue of an ethylenically unsaturated monomer comprising a silicon-containing functional group comprising at least one alkoxy substituent in an amount of at least 0.5% by weight, such as at least 1% by weight, such as at least 5% by weight, such as at least 10% by weight, such as at least 20% by weight, such as at least 30% by weight, such as at least 40% by weight, such as at least 50% by weight, such as at least 60% by weight, such as at least 70% by weight, such as at least 80% by weight, such as at least 90% by weight, based on the total weight of the addition polymer. The addition polymer may comprise constitutional units comprising the residue of an ethylenically unsaturated monomer comprising a silicon-containing functional group comprising at least one alkoxy substituent in an amount of 100% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, such as no more than 10% by weight, such as no more than 5% by weight, based on the total weight of the addition polymer. The addition polymer may comprise constitutional units comprising the residue of an ethylenically unsaturated monomer comprising a silicon-containing functional group comprising at least one alkoxy substituent in an amount of 0.5% to 100% by weight, such as 1% to 100% by weight, such as 5% to 100% by weight, such as 10% to 100% by weight, such as 20% to 100% by weight, such as 30% to 100% by weight, such as 40% to 100% by weight, such as 50% to 100% by weight, such as 60% to 100% by weight, such as 70% to 100% by weight, such as 80% to 100% by weight, such as 90% to 100% by weight, such as 0.5% to 90% by weight, such as 1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.5% to 80% by weight, such as 1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as 0.5% to 70% by weight, such as 1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.5% to 60% by weight, such as 1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.5% to 50% by weight, such as 1% to 50% by weight, such as 5% to 50% by weight, such as 10% to 50% by weight, such as 20% to 50% by weight, such as 30% to 50% by weight, such as 40% to 50% by weight, such as 0.5% to 40% by weight, such as 1% to 40% by weight, such as 5% to 40% by weight, such as 10% to 40% by weight, such as 20% to 40% by weight, such as 30% to 40% by weight, such as 0.5% to 30% by weight, such as 1% to 30% by weight, such as 5% to 30% by weight, such as 10% to 30% by weight, such as 20% to 30% by weight, such as 0.5% to 20% by weight, such as 1% to 20% by weight, such as 5% to 20% by weight, such as 10% to 20% by weight, such as 0.5% to 10% by weight, such as 1% to 10% by weight, such as 5% to 10% by weight, such as 0.5% to 5% by weight, such as 1% to 5% by weight, based on the total weight of the addition polymer. The addition polymer may be derived from a reaction mixture comprising the ethylenically unsaturated monomer comprising a silicon-containing functional group comprising at least one alkoxy substituent in an amount of 0.5% to 100% by weight, such as 1% to 100% by weight, such as 5% to 100% by weight, such as 10% to 100% by weight, such as 20% to 100% by weight, such as 30% to 100% by weight, such as 40% to 100% by weight, such as 50% to 100% by weight, such as 60% to 100% by weight, such as 70% to 100% by weight, such as 80% to 100% by weight, such as 90% to 100% by weight, such as 0.5% to 90% by weight, such as 1% to 90% by weight, such as 5% to 90% by weight, such as 10% to 90% by weight, such as 20% to 90% by weight, such as 30% to 90% by weight, such as 40% to 90% by weight, such as 50% to 90% by weight, such as 60% to 90% by weight, such as 70% to 90% by weight, such as 80% to 90% by weight, such as 0.5% to 80% by weight, such as 1% to 80% by weight, such as 5% to 80% by weight, such as 10% to 80% by weight, such as 20% to 80% by weight, such as 30% to 80% by weight, such as 40% to 80% by weight, such as 50% to 80% by weight, such as 60% to 80% by weight, such as 70% to 80% by weight, such as 0.5% to 70% by weight, such as 1% to 70% by weight, such as 5% to 70% by weight, such as 10% to 70% by weight, such as 20% to 70% by weight, such as 30% to 70% by weight, such as 40% to 70% by weight, such as 50% to 70% by weight, such as 60% to 70% by weight, such as 0.5% to 60% by weight, such as 1% to 60% by weight, such as 5% to 60% by weight, such as 10% to 60% by weight, such as 20% to 60% by weight, such as 30% to 60% by weight, such as 40% to 60% by weight, such as 50% to 60% by weight, such as 0.5% to 50% by weight, such as 1% to 50% by weight, such as 5% to 50% by weight, such as 10% to 50% by weight, such as 20% to 50% by weight, such as 30% to 50% by weight, such as 40% to 50% by weight, such as 0.5% to 40% by weight, such as 1% to 40% by weight, such as 5% to 40% by weight, such as 10% to 40% by weight, such as 20% to 40% by weight, such as 30% to 40% by weight, such as 0.5% to 30% by weight, such as 1% to 30% by weight, such as 5% to 30% by weight, such as 10% to 30% by weight, such as 20% to 30% by weight, such as 0.5% to 20% by weight, such as 1% to 20% by weight, such as 5% to 20% by weight, such as 10% to 20% by weight, such as 0.5% to 10% by weight, such as 1% to 10% by weight, such as 5% to 10% by weight, such as 0.5% to 5% by weight, such as 1% to 5% by weight, based on the total weight of polymerizable monomers used in the reaction mixture.

The silicon-containing functional group may alternatively be included in the addition polymer through a post-polymerization addition to the addition polymer. The addition polymer may be polymerized to comprise functional groups that could be post-reacted with a silicon-containing functional group containing compound to introduce the silicon-containing functional group into the addition polymer. For example, the addition polymer may be polymerized to include epoxide functional groups that could be post-reacted with, for example, an aminosilane, or the addition polymer may be polymerized to include hydroxyl functional groups that can be post-reacted with an isocyanato-functional silane, among other methods of incorporation.

The addition polymer may have a silicon-containing functional group equivalent weight of such as at least 500 g/eq, such as at least 750 g/eq, such as at least 1,000 g/eq, such as at least 1,200 g/eq, such as at least 1,500 g/eq, such as at least 2,500 g/eq, such as at least 5,000 g/eq. The addition polymer may have a silicon-containing functional group equivalent weight of no more than 50,000 g/eq, such as no more than 25,000 g/eq, such as no more than 15,000 g/eq, such as no more than 10,000 g/eq, such as no more than 5,000 g/eq, such as no more than 2,500 g/eq, such as no more than 2,000 g/eq. The addition polymer may have a silicon-containing functional group equivalent weight of 500 to 50,000 g/eq, such as 500 to 25,000 g/eq, such as 500 to 15,000 g/eq, such as 500 to 10,000 g/eq, such as 500 to 5,000 g/eq, such as 500 to 2,500 g/eq, such as 500 to 2,000 g/eq, such as 750 to 50,000 g/eq, such as 750 to 25,000 g/eq, such as 750 to 15,000 g/eq, such as 750 to 10,000 g/eq, such as 750 to 5,000 g/eq, such as 750 to 2,500 g/eq, such as 750 to 2,000 g/eq, such as 1,000 to 50,000 g/eq, such as 1,000 to 25,000 g/eq, such as 1,000 to 15,000 g/eq, such as 1,000 to 10,000 g/eq, such as 1,000 to 5,000 g/eq, such as 1,000 to 2,500 g/eq, such as 1,000 to 2,000 g/eq, such as 1,200 to 50,000 g/eq, such as 1,200 to 25,000 g/eq, such as 1,200 to 15,000 g/eq, such as 1,200 to 10,000 g/eq, such as 1,200 to 5,000 g/eq, such as 1,200 to 2,500 g/eq, such as 1,200 to 2,000 g/eq, such as 1,500 to 50,000 g/eq, such as 1,500 to 25,000 g/eq, such as 1,500 to 15,000 g/eq, such as 1,500 to 10,000 g/eq, such as 1,500 to 5,000 g/eq, such as 1,500 to 2,500 g/eq, such as 1,500 to 2,000 g/eq, 2,500 to 50,000 g/eq, such as 2,500 to 25,000 g/eq, such as 2,500 to 15,000 g/eq, such as 2,500 to 10,000 g/eq, such as 2,500 to 5,000 g/eq, such as 5,000 to 50,000 g/eq, such as 5,000 to 25,000 g/eq, such as 5,000 to 15,000 g/eq, such as 5,000 to 10,000 g/eq. As used herein, the silicon-containing functional group equivalent weight refers to a theoretical value determined by dividing the total theoretical weight of the addition polymer by the total number of equivalents of silicon-containing groups theoretically present therein.

The addition polymer may have an alkoxy equivalent weight of at least 75 g/eq, such as at least 100 g/eq, such as at least 250 g/eq, such as at least 500 g/eq, such as at least 750 g/eq, such as at least 1,000 g/eq, such as at least 1,200 g/eq, such as at least 1,500 g/eq, such as at least 2,000 g/eq. The addition polymer may have an alkoxy equivalent weight of no more than 15,000 g/eq, such as no more than 10,000 g/eq, such as no more than 7,500 g/eq, such as no more than 5,000 g/eq, such as no more than 2,500 g/eq, such as no more than 2,000 g/eq, such as no more than 1,500 g/eq, such as no more than 1,000 g/eq, such as no more than 750 g/eq, such as no more than 600 g/eq, such as no more than 500 g/eq. The addition polymer may have an alkoxy equivalent weight of 75 to 15,000 g/eq, such as 75 to 10,000 g/eq, such as 75 to 7,500 g/eq, such as 75 to 5,000 g/eq, such as 75 to 2,500 g/eq, such as 75 to 2,000 g/eq, such as 75 to 1,500 g/eq, such as 75 to 1,000 g/eq, such as 75 to 750 g/eq, such as 75 to 600 g/eq, such as 75 to 500 g/eq, such as 100 to 15,000 g/eq, such as 100 to 10,000 g/eq, such as 100 to 7,500 g/eq, such as 100 to 5,000 g/eq, such as 100 to 2,500 g/eq, such as 100 to 2,000 g/eq, such as 100 to 1,500 g/eq, such as 100 to 1,000 g/eq, such as 100 to 750 g/eq, such as 100 to 600 g/eq, such as 100 to 500 g/eq, such as 250 to 15,000 g/eq, such as 250 to 10,000 g/eq, such as 250 to 7,500 g/eq, such as 250 to 5,000 g/eq, such as 250 to 2,500 g/eq, such as 250 to 2,000 g/eq, such as 250 to 1,500 g/eq, such as 250 to 1,000 g/eq, such as 250 to 750 g/eq, such as 250 to 600 g/eq, such as 250 to 500 g/eq, such as 500 to 15,000 g/eq, such as 500 to 10,000 g/eq, such as 500 to 7,500 g/eq, such as 500 to 5,000 g/eq, such as 500 to 2,500 g/eq, such as 500 to 2,000 g/eq, such as 500 to 1,500 g/eq, such as 500 to 1,000 g/eq, such as 500 to 750 g/eq, such as 500 to 600 g/eq, such as 750 to 15,000 g/eq, such as 750 to 10,000 g/eq, such as 750 to 7,500 g/eq, such as 750 to 5,000 g/eq, such as 750 to 2,500 g/eq, such as 750 to 2,000 g/eq, such as 750 to 1,500 g/eq, such as 750 to 1,000 g/eq, such as 1,000 to 15,000 g/eq, such as 1,000 to 10,000 g/eq, such as 1,000 to 7,500 g/eq, such as 1,000 to 5,000 g/eq, such as 1,000 to 2,500 g/eq, such as 1,000 to 2,000 g/eq, such as 1,000 to 1,500 g/eq, such as 1,200 to 15,000 g/eq, such as 1,200 to 10,000 g/eq, such as 1,200 to 7,500 g/eq, such as 1,200 to 5,000 g/eq, such as 1,200 to 2,500 g/eq, such as 1,200 to 2,000 g/eq, such as 1,200 to 1,500 g/eq, such as 1,500 to 15,000 g/eq, such as 1,500 to 10,000 g/eq, such as 1,500 to 7,500 g/eq, such as 1,500 to 5,000 g/eq, such as 1,500 to 2,500 g/eq, such as 1,500 to 2,000 g/eq, such as 2,000 to 15,000 g/eq, such as 2,000 to 10,000 g/eq, such as 2,000 to 7,500 g/eq, such as 2,000 to 5,000 g/eq, such as 2,000 to 2,500 g/eq. As used herein, the alkoxy equivalent weight refers to a theoretical value determined by dividing the total theoretical weight of the addition polymer by the total number of equivalents of alkoxy groups theoretically present therein.

The addition polymer may comprise constitutional units comprising the residue of other alpha, beta-ethylenically unsaturated monomers. Non-limiting examples of other alpha, beta-ethylenically unsaturated monomers include vinyl aromatic compounds such as styrene, alpha-methyl styrene, alpha-chlorostyrene and vinyl toluene; organic nitriles such as acrylonitrile and methacrylonitrile; allyl monomers such as allyl chloride and allyl cyanide; monomeric dienes such as 1,3-butadiene and 2-methyl-1,3-butadiene; and acetoacetoxyalkyl (meth)acrylates such as acetoacetoxyethyl methacrylate (AAEM) (which may be self-crosslinking). The constitutional units comprising the residue of the other alpha, beta-ethylenically unsaturated monomers may comprise at least 0.5% by weight, such as at least 1% by weight, such as at least 2% by weight, and may be no more than 30% by weight, such as no more than 20% by weight, such as no more than 10% by weight, such as no more than 5% by weight, based on the total weight of the addition polymer. The constitutional units comprising the residue of the other alpha, beta-ethylenically unsaturated monomers may comprise 0.5% to 30% by weight, such as 1% to 20% by weight, such as 2% to 20% by weight, 2% to 10% by weight, such as 2% to 5% by weight, based on the total weight of the addition polymer. The addition polymer may be derived from a reaction mixture comprising the other alpha, beta-ethylenically unsaturated monomers in an amount of 0.5% to 30% by weight, such as 1% to 20% by weight, such as 2% to 20% by weight, 2% to 10% by weight, such as 2% to 5% by weight, based on the total weight of polymerizable monomers used in the reaction mixture.

The monomers and relative amounts may be selected such that the resulting addition polymer has a Tg of 100° C. or less. The resulting addition polymer may have a Tg of, for example, at least −50° C., such as at least −40° C., such as −30° C., such as, −20° C., such as −15° C., such as −10° C., such as −5° C., such as 0° C. The resulting addition polymer may have a Tg of, for example, no more than +70° C., such as no more than +60° C., such as no more than +50° C., such as no more than +40° C., such as no more than +25° C., such as no more than +15° C., such as no more than +10° C., such as no more than +5° C., such as no more than 0° C. The resulting addition polymer may have a Tg of, for example, −50 to +70° C., such as −50 to +60° C., such as −50 to +50° C., such as −50 to +40° C., such as −50 to +25° C., such as −50 to +20° C., such as −50 to +15° C., such as −50 to +10° C., such as −50 to +5° C., such as −50 to 0° C., such as −40 to +50° C., such as −40 to +40° C., such as −40 to +25° C., such as −40 to +20° C., such as −40 to +15° C., such as −40 to +10° C., such as −40 to +5° C., such as −40 to 0° C., such as −30 to +50° C., such as −30 to +40° C., such as −30 to +25° C., such as −30 to +20° C., such as −30 to +15° C., such as −30 to +10° C., such as −30 to +5° C., such as −30 to 0° C., such as −20 to +50° C., such as −20 to +40° C., such as −20 to +25° C., such as −20 to +20° C., such as −20 to +15° C., such as −20 to +10° C., such as −20 to +5° C., such as −20 to 0° C., such as −15 to +50° C., such as −15 to +40° C., such as −15 to +25° C., such as −15 to +20° C., such as −15 to +15° C., such as −15 to +10° C., such as −15 to +5° C., such as −15 to 0° C., such as −10 to +50° C., such as −10 to +40° C., such as −10 to +25° C., such as −10 to +20° C., such as −10 to +15° C., such as −10 to +10° C., such as −10 to +5° C., such as −10 to 0° C., such as −5 to +50° C., such as −5 to +40° C., such as −5 to +25° C., such as −5 to +20° C., such as −5 to +15° C., such as −5 to +10° C., such as −5 to +5° C., such as −5 to 0° C., such as 0 to +50° C., such as 0 to +40° C., such as 0 to +25° C., such as 0 to +20° C., such as 0 to +15° C. A lower Tg that is below 0° C. may be desirable to ensure acceptable battery performance at low temperature.

The addition polymers may be prepared by conventional free radical initiated solution polymerization techniques in which the polymerizable monomers are dissolved in a second organic medium comprising a solvent or a mixture of solvents and polymerized in the presence of a free radical initiator until conversion is complete. The second organic medium used to prepare the addition polymer may be the same as the organic medium present in the slurry composition such that the composition of the organic medium is unchanged by addition of the addition polymer solution. For example, the second organic medium may comprise the same primary solvent(s) and co-solvent(s) in the same ratios as the organic medium of the slurry composition. Alternatively, the second organic medium used to prepare the addition polymer may be different and distinct from the organic medium of the slurry composition. The second organic medium used to produce the addition polymer may comprise any suitable organic solvent or mixture of solvents, including those discussed above with respect to the organic medium, such as, for example, triethylphosphate.

Examples of free radical initiators are those which are soluble in the mixture of monomers such as azobisisobutyronitrile, azobis(alpha, gamma-methylvaleronitrile), tertiary-butyl perbenzoate, tertiary-butyl peracetate, benzoyl peroxide, ditertiary-butyl peroxide and tertiary amyl peroxy 2-ethylhexyl carbonate.

Optionally, a chain transfer agent which is soluble in the mixture of monomers such as alkyl mercaptans, for example, tertiary-dodecyl mercaptan; ketones such as methyl ethyl ketone, chlorohydrocarbons such as chloroform can be used. A chain transfer agent provides control over the molecular weight to give products having required viscosity for various coating applications. Tertiary-dodecyl mercaptan is preferred because it results in high conversion of monomer to polymeric product.

To prepare the addition polymer, the solvent may be first heated to reflux and the mixture of polymerizable monomers containing the free radical initiator may be added slowly to the refluxing solvent. The reaction mixture is then held at polymerizing temperatures so as to reduce the free monomer content, such as to below 1.0 percent and usually below 0.5 percent, based on the total weight of the mixture of polymerizable monomers.

For use in the slurry composition of the disclosure, the dispersants prepared as described above usually have a weight average molecular weight of about 5,000 to 500,000 g/mol, such as 10,000 to 100,000 g/mol, and 25,000 to 50,000 g/mol.

The dispersant may be present in the binder in amounts of at least 0.1% by weight, such as at least 0.25% by weight, such as at least 0.5% by weight, such as at least 1% by weight, such as at least 2% by weight, such as at least 3% by weight, such as at least 4% by weight, such as at least 5% by weight, such as at least 6% by weight, such as at least 7% by weight, such as at least 8% by weight, at least 12% by weight, based on the total weight of the binder solids. The dispersant may be present in the binder in amounts of no more than 25% by weight, such as no more than 20% by weight, such as no more than 15% by weight, such as no more than 12.5% by weight, such as no more than 10% by weight, such as no more than 5% by weight, based on the total weight of the binder solids. The dispersant may be present in the binder in amounts of 0.1% to 25% by weight, such as 0.1% to 20% by weight, such as 0.1% to 15% by weight, such as 0.1% to 12.5% by weight, such as 0.1% to 10% by weight, such as 0.1% to 8% by weight, such as 0.1% to 7% by weight, such as 0.1% to 6% by weight, such as 0.1% to 5% by weight, such as 0.25% to 25% by weight, such as 0.25% to 20% by weight, such as 0.25% to 15% by weight, such as 0.25% to 12.5% by weight, such as 0.25% to 10% by weight, such as 0.25% to 8% by weight, such as 0.25% to 7% by weight, such as 0.25% to 6% by weight, such as 0.25% to 5% by weight, such as 0.5% to 25% by weight, such as 0.5% to 20% by weight, such as 0.5% to 15% by weight, such as 0.5% to 12.5% by weight, such as 0.5% to 10% by weight, such as 0.5% to 8% by weight, such as 0.5% to 7% by weight, such as 0.5% to 6% by weight, such as 0.5% to 5% by weight, such as 1% to 25% by weight, such as 1% to 20% by weight, such as 1% to 15% by weight, such as 1% to 12.5% by weight, such as 1% to 10% by weight, such as 1% to 8% by weight, such as 1% to 7% by weight, such as 1% to 6% by weight, such as 1% to 5% by weight, such as 2% to 25% by weight, such as 2% to 20% by weight, such as 2% to 15% by weight, such as 2% to 12.5% by weight, such as 2% to 10% by weight, such as 2% to 8% by weight, such as 2% to 7% by weight, such as 2% to 6% by weight, such as 2% to 5% by weight, such as 3% to 25% by weight, such as 3% to 20% by weight, such as 3% to 15% by weight, such as 3% to 12.5% by weight, such as 3% to 10% by weight, such as 3% to 8% by weight, such as 3% to 7% by weight, such as 3% to 6% by weight, such as 3% to 5% by weight, such as 4% to 25% by weight, such as 4% to 20% by weight, such as 4% to 15% by weight, such as 4% to 12.5% by weight, such as 4% to 10% by weight, such as 4% to 8% by weight, such as 4% to 7% by weight, such as 4% to 6% by weight, such as 4% to 5% by weight, such as 5% to 25% by weight, such as 5% to 20% by weight, such as 5% to 15% by weight, such as 5% to 12.5% by weight, such as 5% to 10% by weight, such as 5% to 8% by weight, such as 5% to 7% by weight, such as 5% to 6% by weight, such as 6% to 25% by weight, such as 6% to 20% by weight, such as 6% to 15% by weight, such as 6% to 12.5% by weight, such as 6% to 10% by weight, such as 6% to 8% by weight, such as 6% to 7% by weight, such as 7% to 25% by weight, such as 7% to 20% by weight, such as 7% to 15% by weight, such as 7% to 12.5% by weight, such as 7% to 10% by weight, such as 7% to 8% by weight, such as 8% to 25% by weight, such as 8% to 20% by weight, such as 8% to 15% by weight, such as 8% to 12.5% by weight, such as 8% to 10% by weight, such as 12% to 25% by weight, such as 12% to 20% by weight, such as 12% to 15% by weight, based on the total weight of the binder solids.

The dispersant may be present in the slurry composition in an amount of at least 0.1% by weight, such as at least 0.25% by weight, such as at least 0.5% by weight, such as at least 0.75% by weight, such as at least 1% by weight, such as at least 1.3% by weight, such as at least 1.5% by weight, such as at least 1.9% by weight, based on the total solids weight of the slurry composition. The dispersant may be present in the slurry composition in an amount of no more than 10% by weight, such as no more than 6% by weight, such as no more than 4.5% by weight, such as no more than 2.9% by weight, such as no more than 2.5% by weight, such as no more than 2% by weight, based on the total solids weight of the slurry composition. The dispersant may be present in the slurry composition in an amount of 0.1% to 10% by weight, such as 0.1% to 6% by weight, such as 0.1% to 4.5% by weight, such as 0.1% to 2.9% by weight, such as 0.1% to 2.5% by weight, such as 0.1% to 2% by weight, such as 0.25% to 10% by weight, such as 0.25% to 6% by weight, such as 0.25% to 4.5% by weight, such as 0.25% to 2.9% by weight, such as 0.25% to 2.5% by weight, such as 0.25% to 2% by weight, such as 0.5% to 10% by weight, such as 0.5% to 6% by weight, such as 0.5% to 4.5% by weight, such as 0.5% to 2.9% by weight, such as 0.5% to 2.5% by weight, such as 0.5% to 2% by weight, such as 0.75% to 10% by weight, such as 0.75% to 6% by weight, such as 0.75% to 4.5% by weight, such as 0.75% to 2.9% by weight, such as 0.75% to 2.5% by weight, such as 0.75% to 2% by weight, such as 1% to 10% by weight, such as 1% to 6% by weight, such as 1% to 4.5% by weight, such as 1% to 2.9% by weight, such as 1% to 2.5% by weight, such as 1% to 2% by weight, such as 1.3% to 10% by weight, such as 1.3% to 6% by weight, such as 1.3% to 4.5% by weight, such as 1.3% to 2.9% by weight, such as 1.3% to 2.5% by weight, such as 1.3% to 2% by weight, such as 1.5% to 10% by weight, such as 1.5% to 6% by weight, such as 1.5% to 4.5% by weight, such as 1.5% to 2.9% by weight, such as 1.5% to 2.5% by weight, such as 1.5% to 2% by weight, such as 1.9% to 10% by weight, such as 1.9% to 6% by weight, such as 1.9% to 4.5% by weight, such as 1.9% to 2.9% by weight, such as 1.9% to 2.5% by weight, such as 1.9% to 2% by weight, such as 1% to 10% by weight, such as 1% to 6% by weight, such as 1% to 4.5% by weight, such as 1% to 2.9% by weight, such as 1% to 2.5% by weight, such as 1% to 2% by weight, based on the total solids weight of the slurry composition.

The battery electrode slurry composition may optionally further comprise a separately added crosslinking agent for reaction with the dispersant and/or fluoropolymer (if the fluoropolymer comprises reactive functional groups). The crosslinking agent should be soluble or dispersible in the organic medium and be reactive with active hydrogen groups of the dispersant and/or fluoropolymer, such as carboxylic acid groups and hydroxyl groups, if present. Non-limiting examples of suitable crosslinking agents include aminoplast resins, blocked polyisocyanates and polyepoxides.

Examples of aminoplast resins for use as a crosslinking agent are those which are formed by reacting a triazine such as melamine or benzoguanamine with formaldehyde. These reaction products contain reactive N-methylol groups. Usually, these reactive groups are etherified with methanol, ethanol, butanol including mixtures thereof to moderate their reactivity. For the chemistry preparation and use of aminoplast resins, see “The Chemistry and Applications of Amino Crosslinking Agents or Aminoplast”, Vol. V, Part II, page 21 ff., edited by Dr. Oldring; John Wiley & Sons/Cita Technology Limited, London, 1998. These resins are commercially available under the trademark MAPRENAL® such as MAPRENAL MF980 and under the trademark CYMEL® such as CYMEL 303 and CYMEL 1128, available from Cytec Industries.

Blocked polyisocyanate crosslinking agents are typically diisocyanates such as toluene diisocyanate, 1,6-hexamethylene diisocyanate and isophorone diisocyanate including isocyanato dimers and trimers thereof in which the isocyanate groups are reacted (“blocked”) with a material such as epsilon-caprolactone and methylethyl ketoxime. At curing temperatures, the blocking agents unblock exposing isocyanate functionality that is reactive with the hydroxyl functionality associated with the (meth)acrylic polymer. Blocked polyisocyanate crosslinking agents are commercially available from Covestro as DESMODUR BL.

Examples of polyepoxide crosslinking agents are epoxy-containing (meth)acrylic polymers such as those prepared from glycidyl methacrylate copolymerized with other vinyl monomers, polyglycidyl ethers of polyhydric phenols such as the diglycidyl ether of bisphenol A; and cycloaliphatic polyepoxides such as 3,4-epoxycyclohexylmethyl-3,4-epoxycyclohexane carboxylate and bis(3,4-epoxy-6-methylcyclohexyl-methyl) adipate.

In addition to promoting the cross-linking of the dispersant, the crosslinking agents, including those associated with crosslinking monomers and separately added crosslinking agents, react with the hydrophilic groups, such as active hydrogen functional groups of the dispersant preventing these groups from absorbing moisture that could be problematic in a lithium ion battery.

The separately added crosslinking agent may be present in the binder in amounts of up to 25% by weight, such as 0.1% to 25% by weight, such as 0.1% to 15% by weight, such as 0.1% to 5% by weight, such as 1% to 25% by weight, such as 1% to 15% by weight, such as 1% to 10% by weight, such as 1% to 5% by weight, the % by weight being based on the total weight of the binder solids.

As used herein, the term “binder solids” includes the fluoropolymer and, if present, the dispersant, and the separately added crosslinking agent.

The binder solids may be present in the slurry composition in amounts of at least 0.1% by weight, such as at least 0.5% by weight, such as at least 1% by weight, such as at least 1.5% by weight, such as at least 2% by weight, based on the total solids weight of the slurry. The binder solids may be present in the slurry composition in amounts of no more than 20% by weight, such as no more than 15% by weight, such as no more than 10% by weight, such as no more than 7.5% by weight, such as no more than 5% by weight, such as no more than 4% by weight, such as no more than 3% by weight, based on the total solids weight of the slurry. The binder solids may be present in the slurry composition in amounts of 0.1% to 20% by weight, such as 0.1% to 15% by weight, such as 0.1% to 10% by weight, such as 0.1% to 7.5% by weight, such as 0.1% to 5% by weight, such as 0.1% to 4% by weight, such as 0.1% to 3% by weight, such as 0.5% to 20% by weight, such as 0.5% to 15% by weight, such as 0.5% to 10% by weight, such as 0.5% to 7.5% by weight, such as 0.5% to 5% by weight, such as 0.5% to 4% by weight, such as 0.5% to 3% by weight, such as 1% to 20% by weight, such as 1% to 15% by weight, such as 1% to 10% by weight, such as 1% to 7.5% by weight, such as 1% to 5% by weight, such as 1% to 4% by weight, such as 1% to 3% by weight, such as 1.5% to 20% by weight, such as 1.5% to 15% by weight, such as 1.5% to 10% by weight, such as 1.5% to 7.5% by weight, such as 1.5% to 5% by weight, such as 1.5% to 4% by weight, such as 1.5% to 3% by weight, such as 2% to 20% by weight, such as 2% to 15% by weight, such as 2% to 10% by weight, such as 2% to 7.5% by weight, such as 2% to 5% by weight, such as 2% to 4% by weight, such as 2% to 3% by weight, based on the total solids weight of the slurry.

The slurry composition further comprises an electrochemically active material. The material constituting the electrochemically active material contained in the slurry is not particularly limited and a suitable material can be selected according to the type of an electrical storage device of interest.

The electrochemically active material may comprise a positive battery electrode active material for use as an active material for a positive electrode. The electrochemically active material may comprise a material capable of incorporating lithium (including incorporation through lithium intercalation/deintercalation), a material capable of lithium conversion, or combinations thereof. Non-limiting examples of electrochemically active materials capable of incorporating lithium include LiCoO₂, LiNiO₂, LiFePO₄, LiCoPO₄, LiMnO₂, LiMn₂O₄, Li(NiMnCo)O₂, Li(NiCoAl)O₂, carbon-coated LiFePO₄, lithium manganese phosphate (LMP), lithium iron manganese phosphate (LFMP), and combinations thereof. Non-limiting examples of materials capable of lithium conversion include sulfur, LiO₂, FeF₂ and FeF₃, Si, aluminum, tin, SnCo, Fe₃O₄, and combinations thereof.

The electrochemically active material may comprise a negative battery electrode active material for use as an active material for a negative electrode. The electrochemically active material may comprise graphite, lithium titanate, silicon compounds, tin, tin compounds, sulfur, sulfur compounds, or a combination thereof.

The electrochemically active material may be present in the slurry in amounts of 45% to 99% by weight, such as 50% to 99% by weight, such as 55% to 99% by weight, such as 60% to 99% by weight, such as 65% to 99% by weight, such as 70% to 99% by weight, such as 75% to 99% by weight, such as 80% to 99% by weight, such as 85% to 99% by weight, such as 90% to 99% by weight, such as 91% to 99% by weight, such as 94% to 99% by weight, such as 95% to 99% by weight, such as 96% to 99% by weight, such as 97% to 99% by weight, such as 98% to 99% by weight, such as 45% to 98% by weight, such as 50% to 98% by weight, such as 55% to 98% by weight, such as 60% to 98% by weight, such as 65% to 98% by weight, such as 70% to 98% by weight, such as 75% to 98% by weight, such as 80% to 98% by weight, such as 85% to 98% by weight, such as 90% to 98% by weight, such as 91% to 98% by weight, such as 94% to 98% by weight, such as 95% to 98% by weight, such as 96% to 98% by weight, such as 97% to 98% by weight, such as 45% to 96% by weight, such as 50% to 96% by weight, such as 55% to 96% by weight, such as 60% to 96% by weight, such as 65% to 96% by weight, such as 70% to 96% by weight, such as 75% to 96% by weight, such as 80% to 96% by weight, such as 85% to 96% by weight, such as 90% to 96% by weight, such as 91% to 96% by weight, such as 94% to 96% by weight, such as 95% to 96% by weight, based on the total solids weight of the slurry.

The slurry composition of the present disclosure may optionally further comprise an electrically conductive agent. The electrically conductive agent is more likely to be included if the electrochemically active material is a positive electrode active material, although it is not required. Electrically conductive additives may enhance the rates of charge and discharge of lithium-ion batteries. Non-limiting examples of electrically conductive agents include carbonaceous materials such as, activated carbon, carbon black such as acetylene black and furnace black, graphite, graphene, carbon nanotubes, carbon fibers, fullerene, and combinations thereof.

The electrically conductive agent may be present in the slurry in amounts of at least 0.1% by weight, such as at least 0.5% by weight, such as at least 1% by weight, such as at least 1.5% by weight, such as at least 2% by weight, based on the total solids weight of the slurry. The electrically conductive agent may be present in the slurry in amounts of no more than 20% by weight, such as no more than 15% by weight, such as no more than 10% by weight, such as no more than 7.5% by weight, such as no more than 5% by weight, such as no more than 4% by weight, such as no more than 3% by weight, such as no more than 2.5% by weight, based on the total solids weight of the slurry. The electrically conductive agent may be present in the slurry in amounts of 0.1% to 20% by weight, such as 0.1% to 15% by weight, such as 0.1% to 10% by weight, such as 0.1% to 7.5% by weight, such as 0.1% to 5% by weight, such as 0.1% to 4% by weight, such as 0.1% to 3% by weight, such as 0.1% to 2.5% by weight, such as 0.5% to 20% by weight, such as 0.5% to 15% by weight, such as 0.5% to 10% by weight, such as 0.5% to 7.5% by weight, such as 0.5% to 5% by weight, such as 0.5% to 4% by weight, such as 0.5% to 3% by weight, such as 0.5% to 2.5% by weight, such as 1% to 20% by weight, such as 1% to 15% by weight, such as 1% to 10% by weight, such as 1% to 7.5% by weight, such as 1% to 5% by weight, such as 1% to 4% by weight, such as 1% to 3% by weight, such as 1% to 2.5% by weight, such as 1.5% to 20% by weight, such as 1.5% to 15% by weight, such as 1.5% to 10% by weight, such as 1.5% to 7.5% by weight, such as 1.5% to 5% by weight, such as 1.5% to 4% by weight, such as 1.5% to 3% by weight, such as 1.5% to 2.5% by weight, such as 2% to 20% by weight, such as 2% to 15% by weight, such as 2% to 10% by weight, such as 2% to 7.5% by weight, such as 2% to 5% by weight, such as 2% to 4% by weight, such as 2% to 3% by weight, such as 2% to 2.5% by weight, based on the total solids weight of the slurry.

The electrode slurry composition comprising the organic medium, electrochemically active material, electrically conductive agent, binder (which may include a separately added crosslinking agent), additional organic medium, if needed, and optional ingredients, may be prepared by combining the ingredients to form the slurry. These substances can be mixed together by agitation with a known means such as a stirrer, bead mill or high-pressure homogenizer.

As for mixing and agitation for the manufacture of the electrode slurry composition, a mixer capable of stirring these components to such an extent that satisfactory dispersion conditions are met should be selected. The degree of dispersion can be measured with a particle gauge and mixing and dispersion are preferably carried out to ensure that agglomerates of 100 microns or more are not present. Examples of the mixers which meets this condition include ball mill, sand mill, pigment disperser, grinding machine, extruder, rotor stator, pug mill, ultrasonic disperser, homogenizer, planetary mixer, Hobart mixer, and combinations thereof.

The present disclosure is also directed to an electrode formed by the method of the present disclosure. The electrode may be a positive electrode or a negative electrode. The electrode coating film may have a thickness of at least 1 micron, such as 1 to 500 microns (μm), such as 1 to 200 μm, such as 1 to 175 μm such as 1 to 150 μm, such as 25 to 200 μm, such as 25 to 175 μm, such as 25 to 150 μm, such as 30 to 175 μm, such as 30 to 150 μm, such as 30 to 125 μm. The coating film optionally may comprise a cross-linked coating. The substrate (i.e., current collector) may comprise a conductive material, and the conductive material may comprise a metal such as iron, copper, aluminum, nickel, and alloys thereof, as well as stainless steel. For example, the substrate may comprise aluminum or copper in the form of a mesh, sheet or foil. Although the shape and thickness of the current collector are not particularly limited, the current collector may have a thickness of about 0.001 to 0.5 mm, such as a mesh, sheet or foil having a thickness of about 0.001 to 0.5 mm.

The dried coating on the substrate may optionally be pressed. The pressing reduces the coating thickness and increases the coating density. The pressing may be performed by any suitable press. For example, the coated substrate may be pressed by a calendar press. The coated substrate coated by the method of the present disclosure may be easier to press than coated substrates coated with other slurry compositions, such as an NMP-based slurry composition. Accordingly, the pressed coating may have a higher density than those made with other slurry compositions.

The present disclosure is also directed to an electrical storage device. An electrical storage device according to the present disclosure can be manufactured by using the above electrodes prepared by the method of the present disclosure. The electrical storage device comprises an electrode, a counter electrode, a separator, and an electrolyte. The electrode, counter-electrode or both may comprise the electrode of the present disclosure, as long as one electrode is a positive electrode and one electrode is a negative electrode. Electrical storage devices according to the present disclosure include a cell, a battery, a battery pack, a secondary battery, a capacitor, and a supercapacitor.

The electrical storage device includes an electrolytic solution and can be manufactured by using parts such as a separator in accordance with a commonly used method. As a more specific manufacturing method, a negative electrode and a positive electrode are assembled together with a separator there between, the resulting assembly is rolled or bent in accordance with the shape of a battery and put into a battery container, an electrolytic solution is injected into the battery container, and the battery container is sealed up. The shape of the battery may be like a coin, button or sheet, cylindrical, square or flat.

The electrolytic solution may be liquid or gel, and an electrolytic solution which can serve effectively as a battery may be selected from among known electrolytic solutions which are used in electrical storage devices in accordance with the types of a negative electrode active material and a positive electrode active material. The electrolytic solution may be a solution containing an electrolyte dissolved in a suitable solvent. The electrolyte may be conventionally known lithium salt for lithium ion secondary batteries. Examples of the lithium salt include LiClO₄, LiBF₄, LiPF₆, LiCF₃CO₂, LiAsF₆, LiSbF₆, LiB₁₀Cl₁₀, LiAlCl₄, LiCl, LiBr, LiB(C₂H₅)₄, LiB(C₆H₅)₄, LiCF₃SO₃, LiCH₃SO₃, LiC₄F₉SO₃, Li(CF₃SO₂)₂N, LiB₄CH₃SO₃Li and CF₃SO₃Li. The solvent for dissolving the above electrolyte is not particularly limited and examples thereof include carbonate compounds such as propylene carbonate, ethylene carbonate, butylene carbonate, dimethyl carbonate, methyl ethyl carbonate and diethyl carbonate; lactone compounds such as γ-butyl lactone; ether compounds such as trimethoxymethane, 1,2-dimethoxyethane, diethyl ether, 2-ethoxyethane, tetrahydrofuran and 2-methyltetrahydrofuran; and sulfoxide compounds such as dimethyl sulfoxide. The concentration of the electrolyte in the electrolytic solution may be 0.5 to 3.0 mole/L, such as 0.7 to 2.0 mole/L.

During discharge of a lithium ion electrical storage device, lithium ions may be released from the negative electrode and carry the current to the positive electrode. This process may include the process known as deintercalation. During charging, the lithium ions migrate from the electrochemically active material in the positive electrode to the negative electrode where they become embedded in the electrochemically active material present in the negative electrode. This process may include the process known as intercalation.

As used herein, the term “polymer” refers broadly to oligomers and both homopolymers and copolymers. The term “resin” is used interchangeably with “polymer”.

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₂ substituted acrylic acids, such as methacrylic acid, 2-ethylacrylic acid, etc., and their C₁-C₄ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer. The term “(meth)acrylic polymer” refers to polymers prepared from one or more (meth)acrylic monomers.

As used herein molecular weights are determined by gel permeation chromatography using a polystyrene standard. Unless otherwise indicated molecular weights are on a weight average basis. As used herein, the term “weight average molecular weight” or “(M_{w})” means the weight average molecular weight (M_{w}) as determined by gel permeation chromatography (GPC) using Waters 2695 separation module with a Waters 410 differential refractometer (RI detector), linear polystyrene standards having molecular weights of from 580 Da to 365,000 Da, dimethylformamide (DMF) with 0.05 M lithium bromide (LiBr) as the eluent at a flow rate of 0.5 mL/min, and one Shodex Asahipak GF-510 HQ column (300× 7.5 mm, 5 μm) for separation.

The term “glass transition temperature” as used herein is a theoretical value, being the glass transition temperature as calculated by the method of Fox on the basis of monomer composition of the monomer charge according to T. G. Fox, Bull. Am. Phys. Soc. (Ser. II) 1, 123 (1956) and J. Brandrup, E. H. Immergut, Polymer Handbook 3^{rd} edition, John Wiley, New York, 1989.

As used herein, unless otherwise defined, the term substantially free means that the component is present, if at all, in an amount of less than 5% by weight, based on the total weight of the slurry composition.

As used herein, unless otherwise defined, the term essentially free means that the component is present, if at all, in an amount of less than 1% by weight, based on the total weight of the slurry composition.

As used herein, unless otherwise defined, the term completely free means that the component is not present in the slurry composition, i.e., 0.00% by weight, based on the total weight of the slurry composition.

As used herein, the term “total solids” refers to the non-volatile components of the slurry composition of the present disclosure and specifically excludes the organic medium.

As used herein, the term “consists essentially of” includes the recited material or steps and those that do not materially affect the basic and novel characteristics of the claimed disclosure.

As used herein, the term “consists of” excludes any element, step or ingredient not recited.

For purposes of the detailed description, it is to be understood that the disclosure may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “an” electrochemically active material, “a” fluoropolymer, “a” dispersant, and “an” electrically conductive agent, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described. Although various embodiments of the disclosure have been described in terms of “comprising”, embodiments consisting essentially of or consisting of are also within the scope of the present disclosure.

As used herein, the terms “on,” “onto,” “applied on,” “applied onto,” “formed on,” “deposited on,” “deposited onto,” mean formed, overlaid, deposited, or provided on but not necessarily in contact with the surface. For example, a composition “deposited onto” a substrate does not preclude the presence of one or more other intervening coating layers of the same or different composition located between the electrodepositable coating composition and the substrate.

Whereas specific embodiments of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Example 1: Comparison of Dispersed Fluoropolymer Compared to Fluoropolymer Dissolved in NMP

### Preparation of a Battery Electrode Slurry Composition Having Dispersed Fluoropolymer

A PVDF binder dispersion was prepared that included an organic medium having a blend of primary solvent (TEP) and cosolvent (EAA) mixed in a ratio ranging from 1:1 to 50:1. The organic medium was present in the PVDF binder dispersion in an amount of from 85 parts to 95 parts by weight of the PVDF binder dispersion. To the solvent blend was added, dispersants comprising (meth)acrylic resin(s) having active hydrogen functional groups. The dispersants were present in an amount ranging from 0.1 parts to 5 parts by weight of the PVDF binder dispersion. PVDF was added to the (meth)acrylic/solvent composition in an amount ranging from 5 parts to 15 parts by weight of the PVDF binder dispersion. The PVDF binder dispersion also comprised a crosslinker (e.g., melamine crosslinking agent), which was added last, in the amount of 0.1 parts to 1.0 parts by weight of the PVDF binder dispersion. The % solids ranged from 5% to 15% of the PVDF binder dispersion.

A battery positive electrode slurry was produced that included LiNi_{0.8}Mn_{0.1}Co_{0.1}O₂ positive electrode active material purchased from Gelon (NMC811), Timcal Super P conductive carbon, and the PVDF binder dispersion prepared above. The final slurry solids content was 75.19% by weight. Of the solids present in the positive electrode slurry, NMC811 comprised 96% of the total solids mass, Super P comprised 2% of the total solids mass, and overall binder comprised 2% of the total solids mass. Prior to addition, the Timcal Super P was dried in a vacuum oven overnight at a temperature of 80° C., the NMC811 was used immediately after opening original packaging received from the manufacturers, and all other components were prepared and packaged in a dry (<1% relative humidity) environment. The rheology of the prepared slurry was measured using a 30 mm Parallel Plate method and a 0.5 mm gap at a constant temperature of 25° C. The measured slurry rheology was measured to be:

| | Shear Rate | Viscosity |
|---|---|---|
| | (1/s) | (Pa · s) |
| Dispersed | 0.9 | 3.968 |
| PVDF battery | 2.1 | 2.741 |
| electrode | 4.7 | 2.981 |
| slurry | 9.9 | 2.312 |
| rheology | 21.4 | 2.028 |
| | 46.4 | 1.776 |
| | 99.9 | 1.556 |
| | 215.4 | 1.349 |
| | 464.2 | 1.156 |
| | 1000.0 | 0.942 |

Next, the vessel containing the positive electrode slurry composition was sealed to the external environment, the nitrogen gas feed line was turned off, and the slurry continued to mix at a speed of approximately 1000 rpm until just prior to coating. For coating, the slurry was transferred to a 40 L vessel with a low-rpm paddle-style mixer blade for slow, continuous slurry agitation where it was degassed under vacuum and sealed off from the environment until coating began.

### Preparation of a Battery Electrode Slurry Composition Having Solubilized Fluoropolymer in NMP

The control positive electrode slurry was produced using a standard N-methyl-2-pyrrolidone (NMP) solvent-based composition that included 63360 grams of LiNi_{0.8}Mn_{0.1}Co_{0.1}O₂ (NMC811) positive electrode active material purchased from Gelon, 1320 g of Timcal Super P conductive carbon, 1320 g of Solvay Solef 5130 PVDF binder material, and 35020 g of NMP solvent. The final slurry batch size was 101020 g with a solids fraction of 65.93% by weight. Of the solids present in the positive electrode slurry, NMC811 comprised 96% of the total solids mass, Super P comprised 2% of the total solids mass, and Solef 5130 comprised 2% of the total solids mass. Prior to addition, the Timcal Super P was dried in a vacuum oven overnight at a temperature of 80° C., and all other components were added immediately after opening original packaging received from the manufacturers.

The control positive electrode slurry was mixed in a 60 liter vessel using a high-torque single shaft mixer using two six-inch Cowles disperser blades, with one blade at the base of the mixing shaft and another four inches above it on the same shaft. For the duration of the mixing procedure, nitrogen gas was slowed in the vessel in order to keep the mixing environment at a positive pressure of dry nitrogen gas. At the start of mixing, 32960 g of NMP was added to the vessel. The mixer was then set to 375 rpm in order to obtain a shallow vortex in the mixing vessel. Next, the 1320 g of Solef 5130 PVDF powder was added to the mixing vessel at a rate not exceeding 100 g every 10 min. After all of the PVDF powder was added, the vessel continued mixing at a speed of 570 rpm for 30 min in order to maintain a shallow vortex in the mixing vessel. At this point, the mixing vessel's water-cooled jacket was turned on and set to maintain a vessel wall temperature of 20° C., where it remained until the finished slurry was removed from the mixing vessel. After that, the 1320 g of Timcal Super P carbon additive was added to the mixing vessel, with the mixing shaft continuing to spin, at a rate not exceeding 100 g every 10 min. Upon completion of the Super P addition, the dispersion was mixed for 30 minutes at a speed able to maintain a shallow vortex in the mixing vessel. Then, the 63360 g NMC811 powder was added to the mixing vessel at a rate of 500 g every 10 minutes. After all of the NMC811 powder was added, the slurry continued to mix for 120 minutes at a speed of 815 rpm to maintain a shallow vortex in the mixing vessel. After these steps, an additional 2060 g of NMP was added to the mixing vessel to reduce the slurry viscosity to bring it within the slot-die coater's slurry specification. At this stage, the solids composition of the finished slurry was measured to be 65.93%. The rheology of the slurry was measured using a 30 mm Parallel Plate method and a 0.5 mm gap at a constant temperature of 25° C. The measured slurry rheology was:

| | Shear Rate | Viscosity |
|---|---|---|
| | (1/s) | (Pa · s) |
| Dissolved | 0.9 | 3.007 |
| PVDF | 2.1 | 3.331 |
| positive | 4.7 | 3.266 |
| electrode | 9.9 | 2.712 |
| slurry | 21.4 | 2.116 |
| rheology | 46.4 | 1.713 |
| | 99.9 | 1.409 |
| | 215.4 | 1.163 |
| | 464.2 | 0.953 |
| | 1000.0 | 0.765 |

Once the slurry was in the desired range, the vessel was sealed to the external environment, the nitrogen gas feed line was turned off, and the slurry continued to mix at a speed of 1010 rpm until just prior to coating. For coating, the slurry was transferred to a 40 L vessel with a low-rpm paddle-style mixer blade for slow, continuous slurry agitation where it was degassed under vacuum and sealed off from the environment until coating began.

### Continuous Coating Line Set-up

A continuous coating line having a slot-die coater was used. The setting parameters used for the slot die coater are provided below.

| Parameter | value | |
|---|---|---|
| Solution type | solvent | |
| Coating method | Slot die | |
| Machine lighting | white | |
| Foil width | 300 | mm |
| Core diameter | 6 | inches |

Slot die set up details

| | |
|---|---|
| coating width | 218.4(8.6) |
| slot height | 0.015 |
| Die used | CS15 |
| Other slot height | 0.03 and 0.04 |
| shim type | SS straight |

Residence times and corresponding line speed were evaluated for an 18 meter length oven for preparing coated substrates at a coating weight of 20 mg/cm². The line speed is calculated as Line speed=Oven length/Residence time.

| | Residence time | | | | | | | |
|---|---|---|---|---|---|---|---|---|
| | | | | | | 0.90 min | 0.817 min | 0.75 min |
| | 4.5 min | 2.25 min | 1.5 min | 1.125 min | 1 min | (54 s) | (49 s) | (45 s) |
| Line- | 4 | 8 | 12 | 16 | 18 | 20 | 22 | 24 |
| speed | | | | | | | | |
| (mpm) | | | | | | | | |

Wet films 218.4 mm wide were coated onto an aluminum foil with the slot-die coater. The straight slot-die shims employed ranged from 0.016″-0.036″ tall. The coating pressures ranged from 12-15 psi, 19-92 psi and 20-101 psi for the pump inlet, die inlet and total

| | | Oven Zone | | | | | |
|---|---|---|---|---|---|---|---|
| | | 1 | 2 | 3 | 4 | 5 | 6 |
| Above | Temp (° C.) | 95 | 100 | 110 | 115 | 120 | 120 |
| Coating | supply P (kPa) | 0.1 | 0.1 | 0.2 | 0.2 | 0.2 | 0.2 |
| | exhaust P (Pa) | 20 | 20 | 20 | 20 | 20 | 20 |
| Below | Temp (° C.) | 95 | 100 | 110 | 115 | 120 | 120 |
| Coating | supply P (kPa) | 0.1 | 0.1 | 0.2 | 0.2 | 0.2 | 02 |
| | xhaust P (Pa) | 20 | 20 | 20 | 20 | 20 | 20 |

system pressures. To maintain the target coating weight (20 mg/cm²) slurry flow rates increases increased from 233-1352 g/min for the slurry having dispersed fluoropolymer and 265-1605 g/min for the slurry having solubilized fluoropolymer. All wet films were passed through an 18 meter oven with 6 individual drying zones (D1-D6). The oven set temperatures ranged from 95° C.-120° C. In addition to variable zone temperatures, the supply and exhaust pressure were set for the regions above and below the coating.

During coating the foil temperatures were continuously monitored every 3 meters with the results shown in the table below.

| | | | D1 set | D2 set | D3 set | D4 set | D5 set | D6 set |
|---|---|---|---|---|---|---|---|---|
| | | | temp/° C. | temp/° C. | temp/° C. | temp/° C. | temp/° C. | temp/° C. |
| | | | 95 | 100 | 110 | 115 | 120 | 120 |
| | | | D1 web | D2 web | D3 web | D4 web | D5 web | D6 web |
| | | | temp/° C. | temp/° C. | temp/° C. | temp/° C. | temp/° C. | temp/° C. |
| Dissolved | Machine | 4 | 87.33 | 91.55 | 111.05 | 109.77 | 118.15 | 114.21 |
| PVDF | speed | 8 | 85.17 | 81.82 | 104.53 | 117.12 | 119.32 | 115.72 |
| | (mpm) | 12 | 92.13 | 97.06 | 111.12 | 117.38 | 119.8 | 116.58 |
| | | 12 | 84.76 | 86.8 | 104.65 | 115.76 | 120.25 | 118.65 |
| | | 16 | 86.26 | 90.45 | 104.85 | 113.39 | 118.11 | 120.54 |
| | | 20 | 83.96 | 82.72 | 100.4 | 101.14 | 117.61 | 120.52 |
| | | 24 | 83.25 | 91.8 | 103.88 | 112.98 | 119.16 | 120.91 |
| | | 18 | 84.86 | 82.57 | 104.16 | 117.45 | 119.89 | 121.57 |
| | | 18 | 85.9 | 89.09 | 104.56 | 114.15 | 118.9 | 120.71 |
| Dispersed | Machine | 4 | 88.59 | 81.68 | 100.02 | 99.37 | 117.05 | 120.5 |
| PVDF | speed | 8 | 89.75 | 89.6 | 100.94 | 96.5 | 116.1 | 120.15 |
| | (mpm) | 8 | 90.06 | 93.37 | 108.49 | 112.19 | 116.6 | 120.74 |
| | | 12 | 88.58 | 89.93 | 108.76 | 107.7 | 118.39 | 120.73 |
| | | 16 | 89.26 | 96 | 110.37 | 115.2 | 118.66 | 120.87 |
| | | 18 | 88.93 | 91.9 | 108.55 | 114.39 | 118.79 | 121.16 |
| | | 20 | 88.44 | 91.74 | 108.01 | 115.11 | 119.14 | 121.31 |
| | | 22 | 87.69 | 94.96 | 107.66 | 114.51 | 118.45 | 120.38 |
| | | 24 | 86.33 | 86.42 | 103.8 | 107.25 | 118.62 | 120.72 |
| | | 16 | 88.33 | 97.17 | 108.62 | 115.03 | 118.97 | 120.86 |

Dry film samples were evaluated for coating weight and residual solvent through gravimetric analysis. 6 24 mm diameter circles were cut, weighed, dried at 120° C. for 10 minutes and reweighed to calculate the coating weight (mg/cm²). The results are presented below.

| | | | Pre-Secondary | Post-Secondary | |
|---|---|---|---|---|---|
| | | | Dry / mg · cm⁻² | Dry / mg · cm⁻² | % Decrease |
| Dissolved | Machine | 4 | 19.94 | 19.88 | 0.3% |
| PVDF | speed (mpm) | 8 | 21.02 | 20.84 | 0.9% |
| | | 12 | 21.31 | 21.26 | 0.2% |
| | | 12 | 20.42 | 20.41 | 0.0% |
| | | 16 | 20.89 | 20.78 | 0.5% |
| | | 20 | 20.36 | 20.35 | 0.1% |
| | | 24 | 23.33 | 23.49 | −0.7% |
| | | 18 | 20.19 | 20.14 | 0.2% |
| | | | Pre-Secondary | Post-Secondary | |
| | | | Dry / mg · cm⁻² | Dry / mg · cm⁻² | % Decrease |
| Dispersed | Machine | 4 | 20.17 | 20.15 | 0.1% |
| PVDF | speed (mpm) | 8 | 22.47 | | |
| | | 8 | 19.60 | 19.60 | 0.0% |
| | | 12 | 20.91 | 20.90 | 0.0% |
| | | 16 | 20.39 | 20.24 | 0.7% |
| | | 18 | 20.42 | 20.41 | 0.1% |
| | | 20 | 20.58 | 20.52 | 0.3% |
| | | 22 | 20.84 | 20.82 | 0.1% |
| | | 24 | 18.44 | | |
| | | 18 | 20.35 | 20.35 | 0.0% |

Visual inspection was taken on the unpressed films. It was clear that the film qualities were different between those deposited from the composition having dispersed fluoropolymer and those deposited from the composition having solubilized fluoropolymer. The observations were summarized in the table below.

| Binder | 4 mpm | 8 mpm | 12 mpm | 16 mpm | 18 mpm | 20 mpm | 22 mpm | 24 mpm |
|---|---|---|---|---|---|---|---|---|
| Solubilized | good | good | small | cracks | cracks | cracks/non | NA | NA |
| PVDF | | | cracks | | | uniform | | |
| | | | | | | thickness | | |
| Dispersed | good | good | good | good | good | good | good | good, |
| PVDF | | | | | | | | but low |
| | | | | | | | | loading |

As demonstrated in the table above, the electrode slurry composition applied by a continuous coating method was able to be applied and maintain good film quality at faster speeds when the electrode slurry composition included PVDF dispersed in the organic medium compared to PVDF solubilized in NMP.

### Example 2: Comparison of Dispersed or Dissolved Fluoropolymer in a Non-NMP Organic Solvent Compared to Fluoropolymer Dissolved in NMP

### Preparation of a Battery Electrode Slurry Composition Having Dispersed Fluoropolymer with LFP Active Material (Experimental 1)

A PVDF binder dispersion was prepared that included an organic medium having a blend of primary solvent (TEP) and cosolvent (EAA) mixed in a ratio ranging from 1:1 to 50:1. The organic medium was present in the PVDF binder dispersion in an amount of from 80 parts to 95 parts by weight of the PVDF binder dispersion. To the solvent blend was added, dispersants comprising (meth)acrylic resin(s) having active hydrogen functional groups and heterocyclic groups. The dispersants were present in an amount ranging from 0.1 parts to 5 parts by weight of the PVDF binder dispersion. PVDF was added to the (meth)acrylic/solvent composition in an amount ranging from 3 parts to 15 parts by weight of the PVDF binder dispersion. The PVDF binder dispersion also comprised a crosslinker (e.g., melamine crosslinking agent), which was added last, in the amount of 0.1 parts to 1.0 parts by weight of the PVDF binder dispersion. The % solids ranged from 5% to 15% of the PVDF binder dispersion.

A battery positive electrode slurry was produced that included lithium iron phosphate LiFePO₄ as the positive active material, a mixture of conductive carbons, and the PVDF binder dispersion prepared above. The mixture of conductive carbons was comprised of Denka Black Li(available from Denka Co., Ltd) and Carbon ECP (a carbon black pigment available from Lion Specialty, Co.). The final slurry solids content was 48.7% by weight. Of the solids present in the positive electrode slurry, LFP comprised 92% of the total solids mass, conductive carbon comprised 4% of the total solids mass, and overall binder comprised 4% of the total solids mass. The rheology of the prepared slurry was 4680 cps measured on a viscometers equipped with a #6 spindle at a rate of 50 rpm.

### Preparation of a Battery Electrode Slurry Composition Having Dissolved Fluoropolymer with LFP Active Material (Experimental 2)

A PVDF binder solution was prepared using an organic medium comprised of TEP as the primary solvent. The organic medium was present in the PVDF binder solution in an amount of from 80 parts to 95 parts by weight of the PVDF binder dispersion. To the organic medium was added, dispersants comprising (meth)acrylic resin(s) having active hydrogen functional groups and heterocyclic groups. The dispersants were present in an amount ranging from 0.1 parts to 5 parts by weight of the PVDF binder solution. PVDF was added to the (meth)acrylic/solvent composition in an amount ranging from 3 parts to 15 parts by weight of the PVDF binder solution. The PVDF binder solution also comprised a crosslinker (e.g., melamine crosslinking agent), which was added last, in the amount of 0.1 parts to 1.0 parts by weight of the PVDF binder solution. The % solids ranged from 5% to 15% of the PVDF binder solution.

A battery positive electrode slurry was produced that included the same lithium iron phosphate LiFePO₄ positive active material and mixture of conductive carbons as in Experimental 1, and the PVDF binder solution prepared above. The final slurry solids content was 50.1% by weight. Of the solids present in the positive electrode slurry, LFP comprised 92% of the total solids mass, conductive carbon comprised 4% of the total solids mass, and overall binder comprised 4% of the total solids mass. The rheology of the prepared slurry was 4860 cps measured at ambient temperature and humidity on a viscometer equipped with a #6 spindle at a rate of 50 rpm.

### Preparation of a Positive Electrode Battery Electrode Slurry Composition Having Solubilized Fluoropolymer in NMP with LFP Active Material (NMP Control)

The control positive electrode slurry for Example 2 was produced in a manner comparable to the NMP control used in Example 1. However, the same lithium iron phosphate and mixture of conductive carbons used in Experimental 1 and 2 were used in the NMP control. The PVDF binder solution in N-methyl-2-pyrrolidone (NMP) was available from Kureha. The resultant slurry had a solids content of 44.3% by weight. Of the solids present in the positive electrode slurry, LFP comprised 92% of the total solids mass, conductive carbon comprised 4% of the total solids mass, and PVDF comprised 4% of the total solids mass. The rheology of the prepared slurry was 4160 cps measured at ambient temperature and humidity on a viscometer equipped with a #6 spindle at a rate of 50 rpm.

### Comparison of LFP Positive Electrode Slurry Properties

The positive electrode slurries prepared using the experimental PVDF dispersion binder (1) and the PVDF solution binder (2) demonstrated an improvement in solids compared to the PVDF solution binder NMP control with an advantage (i.e., higher solids content) of 4.4% and 5.8% solids by weight, respectively.

### Continuous Coating Line Set-up

A continuous coating line having a slot-die coater was used and the applied coating was dried using a 35 meter oven having 7 drying zones with a recycle fan and exhaust fan in each zone with the coating facility having a temperature of 24±6° C. and a relative humidity of no more than 30%. The coating was applied to a single side or both sides of an aluminum foil. The oven had the following profile:

| | Side of | | | | | | | |
|---|---|---|---|---|---|---|---|---|
| | foil | Zone 1 | Zone 2 | Zone 3 | Zone 4 | Zone 5 | Zone 6 | Zone 7 |
| Temp. | Upper | 100 | 105 | 105 | 115 | 120 | 125 | 130 |
| (° C.) | Down | 105 | 110 | 110 | | | | |
| Recycle | Upper | 1200 | 1200 | 1200 | 700 | 700 | 600 | 550 |
| fan | | | | | | | | |
| speed | Down | 1200 | 1200 | 1200 | | | | |
| (RPM) | | | | | | | | |
| Exhaust | — | 1150 | 600 | | 550 | | 300 | |
| fan | | | | | | | | |
| speed | | | | | | | | |
| RPM) | | | | | | | | |

The positive electrode coatings were applied to carbon coated aluminum foil using the slot-die coating apparatus described above. The resultant films were pressed to a target range of 150±25 microns after calendaring.

The corresponding line speed and residence time within the oven is provided in the table below:

| | Residence time (min.) | | | | | | |
|---|---|---|---|---|---|---|---|
| | 2.33 | 1.94 | 1.75 | 1.52 | 1.40 | 1.25 | 1.17 |
| Line | 15 | 18 | 20 | 23 | 25 | 28 | 30 |
| speed | | | | | | | |
| (m/min) | | | | | | | |

### Processing and Application Improvements

The experimental and control electrode coatings were tested at varying line speeds/residence times to determine residual solvent (of either one or both sides) and, for some of the examples, the dry point (in meters along the length of the oven). The results are presented in the table below.

| Electrode | Line | Residence | Residual | Dry |
|---|---|---|---|---|
| slurry | speed | time | solvent | point |
| composition | (m/min) | (min) | (ppm)¹ | (m) |
| Experimental 1 | 15 | 2.33 | 318 (single side) | 22 |
| | | | 226 (double side) | |
| | 18 | 1.94 | 278 (single side) | 24 |
| | 20 | 1.75 | 340 (single side) | 27 |
| | 23 | 1.52 | 286 (single side) | 28.5 |
| | 25 | 1.40 | 432 (single side) | 32.5 |
| | 28 | 1.25 | 612 (single side) | 33 |
| | 30 | 1.17 | 1195 (single side) | 34 |
| Experimental 2 | 18 | 1.94 | 269 (single side) | — |
| | | | 175 (double side) | |
| | 20 | 1.75 | 285 (single side) | — |
| | 23 | 1.52 | 280 (single side) | — |
| | 25 | 1.4 | 270 (single side) | — |
| Control (NMP) | 15 | 2.33 | 1609 (single side | 24 |
| | | | 1266 (double side) | |

¹Residual solvent was quantified by Gas Chromatography with Flame Ionization Detector (GC/FID). Dimethyl carbonate was used to extract the organic components (solvent and binder) from the dried electrode film which was analyzed by GC/FID.

The results demonstrate that the experimental coatings resulted in a significant reduction in residual solvent present in the electrode coating film. The results further demonstrate that the experimental electrode coatings reach the dry point at earlier in the oven such that the oven length could be reduced or the speed increased resulting in a shorter processing time and/or reduced energy consumption compared to the NMP control.

Pressed positive electrode films were also compared using resistance measurements, which are reported in (2 in the table below. The positive electrode films from the Experimental conditions (1 and 2) had similar or improved conductivity compared to the positive electrode produced from the PVDF binder solubilized in NMP.

| Experimental 1 | Experimental 2 | NMP Control |
|---|---|---|
| Film Resistance (Ω) | Film Resistance (Ω) | Film Resistance (Ω) |
| 1.4 | 0.9 | 1.1 |

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. A method of manufacturing an electrode using a continuous coating line for applying an electrode coating layer on a substrate surface of a substrate, the continuous coating line comprising a coating apparatus comprising a coating head and a coating fluid supply system, and at least one oven comprising a heating element, and a substrate carrier for carrying the substrate, the method comprising:
continuously carrying the substrate through the continuous coating line using the substrate carrier;
continuously applying a battery electrode slurry composition from the coating head to the substrate surface to form a wet coated substrate, wherein the battery electrode slurry composition is continuously fed into the coating head by the coating fluid supply system; and
heating the wet coated substrate in the oven to form a dried coating on the substrate;
wherein the battery electrode slurry composition comprises:
an electrochemically active material comprising a positive battery electrode active material or a negative battery electrode active material;
an organic medium comprising, consisting essentially of, or consisting of a trialkyl phosphate;
a binder comprising:
(a) a fluoropolymer comprising the residue of vinylidene fluoride; and
(b) one or more (meth)acrylic polymers comprising constitutional units comprising the residue of: (i) 40% to 80% by weight of an alkyl ester of (meth)acrylic acid containing from 1 to 3 carbon atoms in the alkyl group; (ii) 18% to 48% by weight of an alkyl ester of (meth)acrylic acid containing from 4 to 18 carbon atoms in the alkyl group; (iii) 0.1% to 10% by weight of a hydroxyalkyl ester; (iv) 0% to 10% by weight of an alpha, beta-ethylenically unsaturated carboxylic acid; and (v) 0% to 20% by weight of an ethylenically unsaturated monomer comprising a heterocyclic group, the % by weight based on the total monomer weight that comprise the one or more (meth)acrylic polymers; and
optionally an electrically conductive agent.

2. The method of claim 1, wherein the fluoropolymer is solubilized in the organic medium.

3. The method of claim 1, wherein the organic medium comprises a solvent system comprising: (i) the trialkyl phosphate; and (ii) a co-solvent comprising a lactone and/or a molecule comprising a sulfoxide and/or sulfone functional group, wherein the trialkyl phosphate and the co-solvent comprise at least 50% by weight of the solvent system, based on the total weight of the solvent system.

4. A method of manufacturing an electrode using a continuous coating line for applying an electrode coating layer on a substrate surface of a substrate, the continuous coating line comprising a coating apparatus comprising a coating head and a coating fluid supply system, and at least one oven comprising a heating element, and a substrate carrier for carrying the substrate, the method comprising:
continuously carrying the substrate through the continuous coating line using the substrate carrier;
continuously applying a battery electrode slurry composition from the coating head to the substrate surface to form a wet coated substrate, wherein the battery electrode slurry composition is continuously fed into the coating head by the coating fluid supply system; and
heating the wet coated substrate in the oven to form a dried coating on the substrate;
wherein the battery electrode slurry composition comprises:
an electrochemically active material comprising a positive battery electrode active material or a negative battery electrode active material;
an organic medium comprises a solvent system comprising, consisting essentially of, or consisting of
(i) a molecule comprising a sulfoxide functional group; and
(ii) a glycol ether and/or ester;
wherein the solvent system includes less than 1% by weight of a molecule comprising the structure R¹C(═O)NR²R³, wherein R¹ is an aliphatic saturated group, that can be linear or branched, having 1 to 6 carbon atoms, and substituted by one or more functional groups comprising —C(═O)OR and —C(═O)NR⁴R⁵, R being an alkyl group having 1 to 6 carbon atoms, and R⁴ and R⁵ each independently are methyl or ethyl groups, and R² and R³ each independently are methyl or ethyl groups, based on the weight of the solvent system;
a binder comprising a fluoropolymer; and
optionally an electrically conductive agent.

5. A method of manufacturing an electrode using a continuous coating line for applying an electrode coating layer on a substrate surface of a substrate, the continuous coating line comprising a coating apparatus comprising a coating head and a coating fluid supply system, and at least one oven comprising a heating element, and a substrate carrier for carrying the substrate, the method comprising:
continuously carrying the substrate through the continuous coating line using the substrate carrier;
continuously applying a battery electrode slurry composition from the coating head to the substrate surface to form a wet coated substrate, wherein the battery electrode slurry composition is continuously fed into the coating head by the coating fluid supply system; and
heating the wet coated substrate in the oven to form a dried coating on the substrate;
wherein the battery electrode slurry composition comprises:
an electrochemically active material comprising a positive battery electrode active material or a negative battery electrode active material;
an organic medium;
a binder comprising a fluoropolymer that is dispersed in the organic medium; and
optionally an electrically conductive agent.

6. The method of claim 5, wherein the organic medium comprises butyl pyrrolidone, trialkyl phosphate, 1,2,3-triacetoxypropane, 3-methoxy-N,N-dimethylpropanamide, ethyl acetoacetate, gamma-butyrolactone, propylene glycol methyl ether, cyclohexanone, propylene carbonate, dimethyl adipate, propylene glycol methyl ether acetate, dibasic ester (DBE), dibasic ester 5,4-hydroxy-4-methyl-2-pentanone, propylene glycol diacetate, dimethyl phthalate, methyl isoamyl ketone, ethyl propionate, 1-ethoxy-2-propanol, dipropylene glycol dimethyl ether, saturated and unsaturated linear and cyclic ketones, diisobutyl ketone, acetate esters, tripropylene glycol methyl ether, diethylene glycol ethyl ether acetate, or combinations thereof.

7. (canceled)

8. The method of claim 5, wherein the organic medium comprises a primary solvent comprising triethyl phosphate and a co-solvent comprising ethyl acetoacetate.

9. (canceled)

10. The method of claim 1, wherein the organic medium has an evaporation rate of at least 100 kg/hr.

11. (canceled)

12. The method of claim 1, wherein the organic medium has a lower explosion limit of greater than 1.1% by volume.

13. The method of claim 1, wherein the substrate carrier for carrying the substrate moves the substrate through the continuous coating line at a line speed of at least 1 meters/minute (mpm).

14. The method of claim 1, wherein the oven has a length of 1 to 80 meters.

15. The method of claim 14, wherein a ratio of the line speed to the oven length is at least 1 mpm to 5 meter of oven length (1:5).

16. The method of claim 1, wherein the residence time of the substrate in the oven is 5 minutes or less.

17. (canceled)

18. The method of claim 1, wherein the continuous coating process is a roll-to-roll coating line.

19. The method of claim 1, wherein coating apparatus comprises a slot-die coater or a reverse comma coater.

20. The method of claim 1, wherein the continuous coating line further comprises a solvent recovery system.

21. The method of claim 1, wherein the dried coating on the substrate is pressed by a calendar press.

22-28. (canceled)

29. The method of claim 1, wherein the battery electrode slurry composition further comprises a dispersant.

30-32. (canceled)

33. An electrode formed according to the method of claim 1.

34-39. (canceled)

40. An electrical storage device comprising:
(a) the electrode of claim 33;
(b) a counter electrode; and
(c) an electrolyte.

41-44. (canceled)
